(19) United States
(12) Patent Application Publication
(10) Pub. No.: US 2023/0289763 A1
(43) Pub. Date: Sep. 14, 2023

(54) INFORMATION PROCESSING DEVICE, POSITION INFORMATION PROVISION METHOD, AND RECORDING MEDIUM

(71) Applicant: NEC Corporation, Minato-ku, Tokyo (JP)

(72) Inventor: Shinya Yamasaki, Tokyo (JP)

(73) Assignee: NEC Corporation, Minato-ku, Tokyo (JP)

(21) Appl. No.: 18/020,824

(22) PCT Filed: Sep. 21, 2021
(86) PCT No.: PCT/JP2021/034515

§ 371 Date: Feb. 10, 2023

(30) Foreign Application Priority Data
Sep. 28, 2020 (JP) 2020-161648

(51) Int. Cl. G06Q 20/20; G06T 7/70

(52) U.S. Cl. CPC G06Q 20/208; G06T 7/70

(57) ABSTRACT

This information processing device includes an acquisition unit and an output unit. The acquisition unit acquires data containing: product information indicating a product acquired by operations performed by a customer; and position information related to the position at which the product information was acquired. The operations performed by the customer include an operation for registering product information and an operation for searching product information. Further, the output unit outputs position information and product information which contains the data acquired by the acquisition unit.

### TECHNICAL FIELD

The present disclosure relates to an information processing device and the like.

### BACKGROUND ART

There is a technology of providing position information of a product in a store. For example, PTLs 1 and 2 disclose a technology of displaying a map indicating a position of a product in a store. Specifically, in PTL 2, when a product code is read by an operation of a clerk, a clerk terminal acquires identification information of a product shelf close to the clerk terminal using a beacon device. Then, in PTL 2, identification information of a product shelf is associated with a product code. In PTL 2, a product display management server displays a position of a product shelf associated to a designated product on a map.

### CITATION LIST

### Patent Literature

[PTL 1] JP 2018-032032 A
[PTL 2] JP 2016-066290 A

### SUMMARY OF INVENTION

### Technical Problem

However, in the technology described in PTL 2 described above, the position information of the product is specified by the operation of the clerk. Therefore, if the operation of the clerk is performed once a day or several days, there is a problem that the position information cannot be changed in real time when the position of the product is changed.

An object of the present disclosure is to provide an information processing device or the like capable of providing highly accurate position information in real time.

### Solution to Problem

An information processing device according to one example embodiment includes: an acquisition means configured to acquire data including product information indicating a product acquired by an operation of a customer and position information related to a position where the product information is acquired; and an output means configured to output the position information and the product information included in the data acquired by the acquisition means.

A position information provision method according to one example embodiment includes: acquiring data including product information indicating a product acquired by an operation of a customer and position information related to a position where the product information is acquired; and outputting the position information and the product information included in the data.

A recording medium according to one example embodiment non-transitorily records a program for causing a computer to execute acquiring data including product information indicating a product acquired by an operation of a customer and position information related to a position where the product information is acquired; and outputting the position information and the product information included in the data.

### Advantageous Effects of Invention

According to the present disclosure, highly accurate position information can be provided in real time.

### BRIEF DESCRIPTION OF DRAWINGS

FIG. 1 is a block diagram illustrating a configuration example of an information processing device according to a first example embodiment.

FIG. 2 is an explanatory diagram illustrating an example of acquired data.

FIG. 3 is a flowchart illustrating an operation example of an information processing device 10 according to the first example embodiment.

FIG. 4 is an explanatory diagram illustrating a configuration example of a system according to a second example embodiment.

FIG. 5 is an explanatory diagram illustrating an example of the inside of a store.

FIG. 6 is a block diagram illustrating a configuration example of an information processing device 20 according to a second example embodiment.

FIG. 7 is an explanatory diagram illustrating an example of the content stored in a display position DB 221.

FIG. 8 is an explanatory diagram illustrating an example of the content stored in area information 222.

FIG. 9 is an explanatory diagram illustrating an example of the content stored in category information 223.

FIG. 10 is an explanatory diagram related to Determination Example 1.

FIG. 11 is an explanatory diagram related to Determination Example 2.

FIG. 12 is an explanatory diagram related to Determination Example 3.

FIG. 13 is an explanatory diagram illustrating a display example.

FIG. 14 is a sequence diagram related to Determination Example 1 of the system 2 according to the second example embodiment.

FIG. 15 is a sequence diagram related to Determination Example 2 of the system 2 according to the second example embodiment.

FIG. 16 is a sequence diagram related to Determination Example 3 of the system 2 according to the second example embodiment.

FIG. 17 is a sequence diagram illustrating a map display example of the system 2 according to the second example embodiment.

FIG. 18 is an explanatory diagram illustrating a hardware configuration example in a case where the information processing device is implemented by a computer.

FIG. 19 is an explanatory diagram illustrating a hardware configuration example in a case where a registration device is implemented by a computer.

### EXAMPLE EMBODIMENT

Hereinafter, example embodiments of an information processing device, a position information provision method, and a program according to the present disclosure will be described in detail with reference to the drawings. The present example embodiment does not limit the disclosed technology.

### FIRST EXAMPLE EMBODIMENT

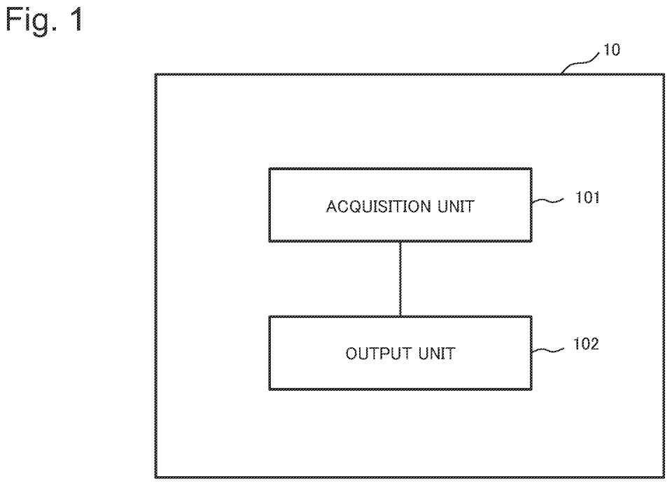

FIG. 1 is a block diagram illustrating a configuration example of an information processing device according to a first example embodiment. An information processing device 10 provides position information of each product in a store. Examples of the store include a supermarket. However, the store is not particularly limited. The product is not particularly limited. The product is displayed, for example, in a store. Referring to FIG. 1, the information processing device 10 includes an acquisition unit 101 and an output unit 102.

For example, the acquisition unit 101 acquires data including product information indicating a product acquired by an operation of a customer and position information related to a position where the product information is acquired. For example, this data is referred to as “acquired data”. Examples of the operation of the customer include an operation in which the customer registers a product in a registration device (this is referred to as a “product registration operation”), an operation in which the customer searches for a product using a search device (this is referred to as a “product search operation”), and the like. First, the product registration operation will be described. The registration device is, for example, a device that enables a customer to register a product at the time of shopping. Registering a product in the registration device means, for example, registering a product to be purchased as a product to be checked out (for example, product information) in the registration device. At this time, the product and the series of registered products are associated with the customer. Being associated with the customer means that, for example, identification information of the customer is associated with product information or a series of product information. As the identification information of the customer, for example, ID information of the customer obtained from information of a point card or the like may be used, or identification information attached to one accounting may be used. As a result, for example, it is possible to determine that the operation is performed by the same customer. Examples of the registration device include a terminal device of a customer, a register installed in a store, a shopping cart having a register function, and the like. As described above, the registration device is not particularly limited. Next, the product search operation will be described. The search device is, for example, a device capable of searching for product information related to a product when a customer purchases the product. For example, the product search operation is, for example, an operation in which a customer searches for a product, a characteristic of the product, a price of the product, and the like. Examples of the search device include a terminal device of a customer, a device or a register provided in a store and having a search function, and a shopping cart having a search function. As described above, the search device is not particularly limited.

The registration device and the search device may be the same device or different devices. For example, the acquisition unit 101 acquires the acquired data including the product information acquired by the device (search device and registration device) by the operation of the customer and the position information related to the position when the product information is acquired by the device. More specifically, the acquisition unit 101 acquires, for example, the acquired data including the product information registered by the registration device in the product registration of the customer and the position information related to the registration device at the time of registering the product. Alternatively, the acquisition unit 101 acquires, for example, acquired data including the product information searched by the search device in the product search for the customer and the position information related to the search device at the time of searching for the product. In the first example embodiment, for ease of description, a registration device will be described as an example of a device operable by a customer. Specifically, for example, the acquisition unit 101 receives the product information and the position information transmitted from the registration device via the communication network.

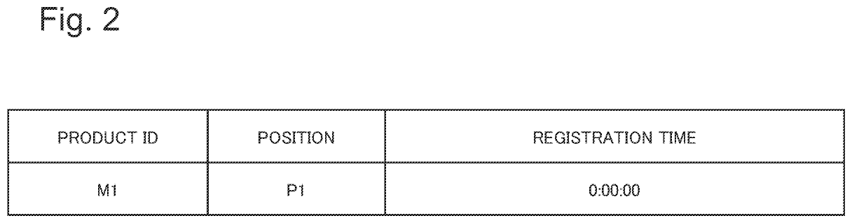

FIG. 2 is an explanatory diagram illustrating an example of acquired data. As illustrated in FIG. 2, the acquired data acquired by the acquisition unit 101 includes, for example, product information and position information. In FIG. 2, examples of the product information include product identification information indicating an identifier (product ID (identify)) of a product. The identifier of the product is hereinafter referred to as a product ID (identify). The product can be identified by the product ID. The position information is position information related to a position where the product information is acquired by the registration device. Specifically, for example, the position information indicates a position related to the registration device. The position related to the registration device is a position of the registration device or a position near the registration device. Examples of the position information include coordinate information indicating a coordinate value in the store, shelf number information indicating a shelf number, and passage information indicating a passage number.

Furthermore, as illustrated in FIG. 2, time information indicating the time at the time of registration by the registration device may be acquired by the acquisition unit 101. The information processing device 10 can manage latest position information, old position information, and the like based on the time information. In addition, instead of the time information, date information indicating a date or date and time information indicating a date and time may be acquired by the acquisition unit 101. Note that the acquisition unit 101 may not acquire the time information from the registration device, and may use the information indicating the time at which the product information and the position information have been acquired as the information indicating the time at the time of registration of the product.

Returning to the description of FIG. 1, the output unit 102 outputs the position information and the product information included in the acquired data. There are various output methods. Examples of the output method include a method of registering in a storage unit and a method of causing an output device to output. When there are a plurality of types of output methods, one or both of the output methods may be performed.

A method of registering in the storage unit will be described. For example, the output unit 102 registers the product information and the position information included in the acquired data in the storage unit. Specifically, the output unit 102 may register the product information and the position information in a database that manages the position information for each product. Alternatively, the output unit 102 may register the product information and the position information in, for example, a database that manages existing products.

A method for causing the output device to output will be described. For example, the output unit 102 causes an output device or the like to output the position information and the product information included in the acquired data. Examples of the output device include a display, a lighting device such as a lamp, a printer, a plotter, a speaker, an earphone, and the like. Specifically, for example, the output unit 102 generates map information related to a map indicating that the target product is present at the registration position. Then, the output unit 102 displays the map indicated by the map information on the display. Here, the information processing device 10 may include an output device. Alternatively, a device connectable to the information processing device via a communication network or the like may have an output device. For example, the output unit 102 transmits the map information to the terminal device of the customer. Accordingly, the terminal device of the customer receives the map information. Then, the terminal device of the customer can display the map indicated by the map information.

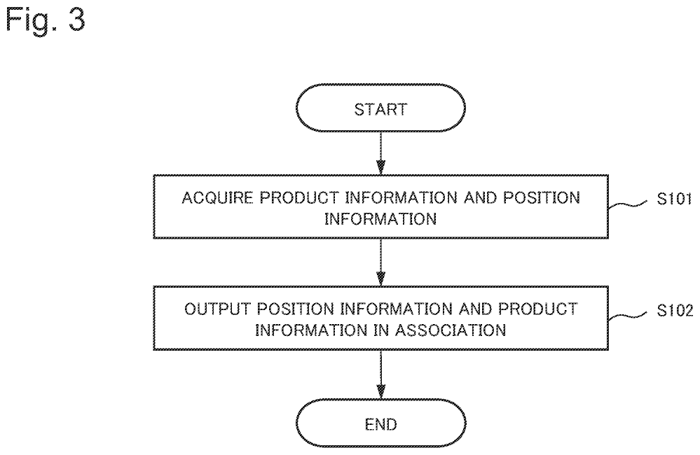

FIG. 3 is a flowchart illustrating an operation example of the information processing device 10 according to the first example embodiment. Here, the processing result of each step by the information processing device 10 in FIG. 3 is stored in a storage unit accessible by the information processing device 10 such as a memory. As illustrated in FIG. 3, first, the information processing device 10 acquires the product information registered by the registration device in the product registration of the customer and the position information related to the registration device at the time of registering the product (step S101). The information processing device 10 outputs the position information and the product information in association with each other (step S102). The information processing device 10 ends the operation of the flow.

As described above, the operation of the customer is not limited to the product registration operation, and may be the product search operation. In addition, in the first example embodiment, the operation by the customer may be either the product registration operation or the product search operation, or may be both. Therefore, in the product search operation, the product information is, for example, product information on the product searched by the search device. The position information is, for example, position information related to a search device at the time of searching for a product. The time information is, for example, time information indicating time at which the search device performs the search.

Next, effects of the first example embodiment will be described. The information processing device 10 according to the present first example embodiment uses the position information at the time of acquiring the product information by the operation of the customer as the product display position. For example, in the product registration operation, the information processing device 10 uses the position of the registration device at the time of registering the product as the display position of the product. For example, in the product search operation, the information processing device 10 uses the position of the search device when searching for a product as the product display position. For example, several tens to several hundreds of customers come to a supermarket, a supermarket center, or the like. When the number of customers is large, the information processing device 10 can collect a large amount of position information of each product in real time. In addition, for example, even in a case where a plurality of different products is suddenly collected like a wagon sale, the information processing device 10 can obtain the position information of the product in real time by the customer registering the product in the registration device. In this manner, the information processing device 10 can provide highly accurate position information in real time. In addition, in the case of specifying the position information of each product by attaching a radio frequency identifier (RFID) or the like to each product, since the price of the RFID is high, it is expensive to attach the RFID to each product. The information processing device 10 can provide position information with high accuracy as compared with a case where an expensive device such as an RFID is used. Therefore, the information processing device 10 can reduce the cost of providing the position information. In addition, the information processing device 10 uses product registration used for a customer to purchase a product. Therefore, the information processing device 10 can provide the position information without another time and effort of the customer. Furthermore, the information processing device 10 may not use an operation such as reading of a product code by a clerk. Therefore, the information processing device 10 can save the time and effort of the clerk.

### Second Example Embodiment

Next, a second example embodiment will be described in detail with reference to the drawings. Hereinafter, description of contents overlapping with the above description will be omitted to the extent that the description of the second example embodiment is not unclear. In the second example embodiment, as in the first example embodiment, the product registration operation is described as an example of the operation by the customer, but the operation may be a product search operation. Therefore, the registration device will be described as an example of the device operable by the customer, but the device operable by the customer may be a search device.

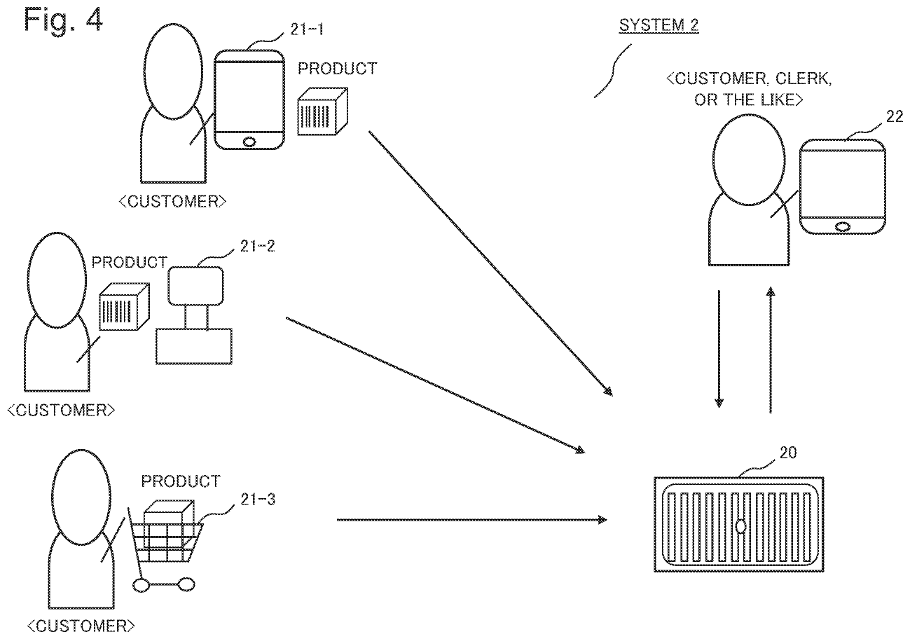

FIG. 4 is an explanatory diagram illustrating a configuration example of a system according to the second example embodiment. In FIG. 4, the system 2 includes an information processing device 20, a plurality of registration devices 21, and a display device 22.

The plurality of registration devices 21-1 to 21-n are devices for registering identification information of a product in order for a customer to settle a product to be purchased at the time of shopping. n is an integer of 1 or more. For example, the registration device 21-1 is a terminal device of a customer. The registration device 21-2 is a register operable by a customer. The registration device 21-2 is installed in a store, for example. The registration device 21-3 is, for example, a shopping cart to which a device having a registration function is attached. Alternatively, the registration device 21-3 is a shopping cart in which a device having a registration function and a cart are integrated. As described above, the type of the registration device 21 is not particularly limited.

For example, the registration device 21 registers a product by a product registration operation. The registration device 21 reads, for example, an image of a product to be purchased or a product code such as a barcode attached to the product to be purchased. A case where the product code is read will be described. The registration device 21 acquires the product information associated to the product code read by the operation of the customer. The product information includes product identification information capable of identifying a product. In addition, the product information may include information related to the price of the product. A case where an image of a product is read will be described. The registration device 21 reads an image of a product by photographing a part or all of the product by an operation of a customer. Then, the registration device 21 acquires product information related to the product based on the image of the product. Specifically, for example, the registration device 21 acquires the product information by discriminating which product from the image of the product. Furthermore, in a case where an image associated to a product to be purchased is selected by the customer from an image of the product displayed on the registration device 21, for example, the registration device 21 acquires product information associated to the selected image. Furthermore, the registration device 21 may acquire, for example, product information associated to a product name, a product number, or the like input by a customer. In this manner, the product is registered in the registration device 21.

For example, the registration device 21-1 includes a reader capable of reading a product code. Examples of the reader include a camera. Then, the registration device 21-1 reads the product code by the reader. Then, the registration device 21-1 acquires, for example, the product information associated to the read product code. Alternatively, the registration device 21-1 obtains an image of a product by photographing the product with a camera. Then, the registration device 21-1 acquires the product information by discriminating the product from the image. In this manner, the registration device 21-1 can register a product, for example. In addition, the registration device 21-2 reads the product code by, for example, the customer holding a scanner capable of reading the product code over the product code. Then, the registration device 21-2 acquires the product information associated to the read product code. In the case of the registration device 21-3, when a customer puts a product in a basket included in a shopping cart, the registration device 21-3 reads a product code of the product by the customer holding the product over a reader or the like. Then, the registration device 21-3 acquires the product information associated to the read product code.

Next, when the product is registered, the registration device 21 acquires position information indicating the position of the registration device 21. In a case where the registration device 21 is a fixed device such as the registration device 21-2, position information of the fixed device is managed in advance. The registration device 21 may obtain the position information from identification information of the fixed device or the like.

Furthermore, the registration device 21 may acquire the position information of the registration device 21 using a beacon device, a camera provided in a store, or the like. For example, a case where a beacon device is used will be described. The plurality of beacon devices are provided in advance on each shelf, passage, or the like in the store. The registration device 21 reads the product code. Then, the registration device 21 receives a beacon signal from the beacon device when the product code is read. For example, the beacon signal includes identification information indicating a shelf, a passage, a beacon device, and the like. Then, the registration device 21 sets the identification information as the position information. For example, in a case where the strength of each beacon signal transmitted from a plurality of beacon devices is the same, the registration device 21 can estimate the position of the registration device 21 assuming that the beacon device is in the vicinity of the beacon device having the strongest strength. Here, the same strength includes substantially the same error or the like.

Furthermore, the registration device 21 may use, for example, position information used to obtain a flow line of a customer or the like as the position information of the registration device 21. In this manner, the position information of the registration device 21 may be obtained by an existing technology. Then, for example, at the time of registering the product, the registration device 21 transmits the registered product information and the position information to the information processing device 20.

In this manner, the registration devices 21-1 to 21-n may be any device that can register the products by the operation of the customer. Further, n is an integer of 1 or more. In addition, an existing technology may be used as a detailed product registration method, a registered product management method, and the like, and thus description thereof is omitted.

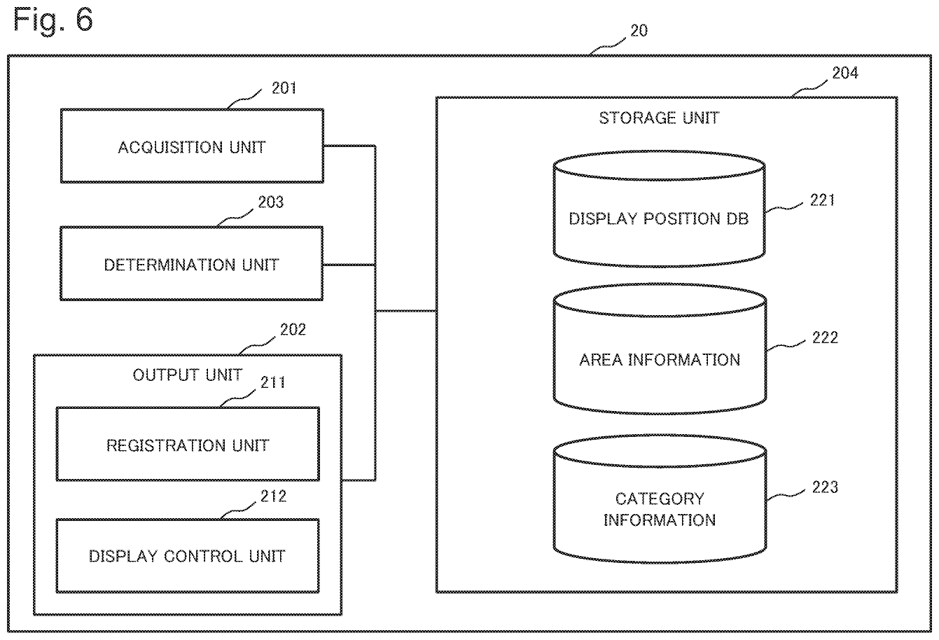

The information processing device 20 provides the position information of the product to the customer and the clerk based on the identification information of the product obtained from the registration device 21 and the position information of the registration device 21. Specifically, for example, the information processing device 20 causes the display device 22 to display a map including the position information of the product. Detailed functions of the information processing device 20 will be described later with reference to FIG. 6. The display device 22 is a device of a customer, a clerk, or the like. The display device 22 displays a map including the position information of the product.

Furthermore, the information processing device 20 and the display device 22 may be the same device. Furthermore, the display device 22 and the registration device 21 may be the same device.

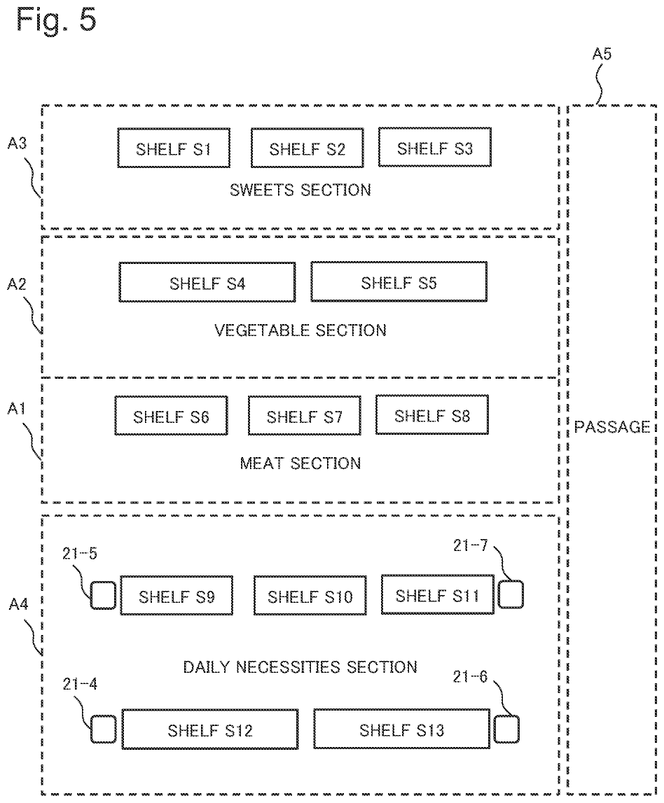

FIG. 5 is an explanatory diagram illustrating an example of the inside of the store. FIG. 5 illustrates an example of a store used for description of the second example embodiment. The store is divided into, for example, a plurality of areas A1 to A5. The plurality of areas A1 to A5 are divided into sections or passages such as a meat section, a vegetable section, a sweets section, and a daily necessities section. In order to facilitate the description of the second example embodiment, for example, an area associated to a section is determined by a category of a product or the like. Each area can be identified by the information processing device 20 by area information to be described later. Furthermore, in the example of FIG. 5, each section is provided with, for example, a shelf on which products can be displayed. FIG. 5 illustrates shelves S1 to S13. For example, shelves S6 to S8 are provided in the area A1 which is a meat section. As an example of an article on which a product can be displayed, the product may be displayed on an article on which a clerk can easily move, such as a wagon or a basket, in addition to a shelf. Furthermore, as in the registration devices 21-4 to 21-7, the registration device 21 provided in the store may be provided near the shelf.

FIG. 6 is a block diagram illustrating a configuration example of the information processing device 20 according to the second example embodiment. In FIG. 6, the information processing device 20 includes, for example, an acquisition unit 201, a determination unit 203, an output unit 202, and a storage unit 204. First, the storage unit 204 stores a processing result of each function of the information processing device 20. In addition, the storage unit 204 stores data used for processing of each unit. The content stored in the storage unit 204 in FIG. 6 is an example, and is not particularly limited.

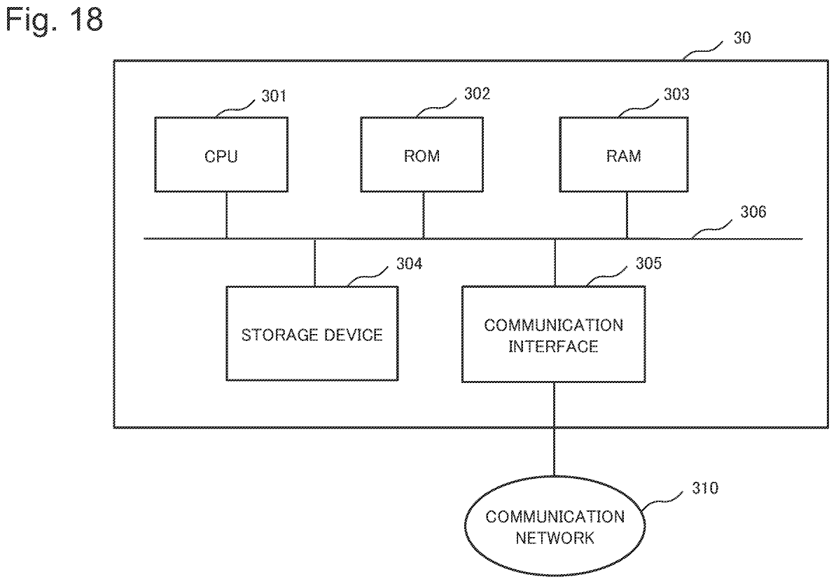

Furthermore, the information processing device 20 only needs to be able to access various data. Therefore, various kinds of data may be stored in a storage device or the like accessible by the information processing device 20 via a communication network. However, as will be described in detail with the hardware configuration example illustrated in FIG. 18, the information processing device 20 loads a program including various commands for achieving each functional unit into the storage unit 204 and executes the program. Examples of the storage unit 204 include a read only memory (ROM), a random access memory (RAM), a semiconductor memory, a hard disk drive (HDD), a solid state drive (SSD), and the like. Furthermore, the storage unit 204 may be a combination thereof.

Specifically, the storage unit 204 stores a display position DB 221, an area information 222, and a category information 223.

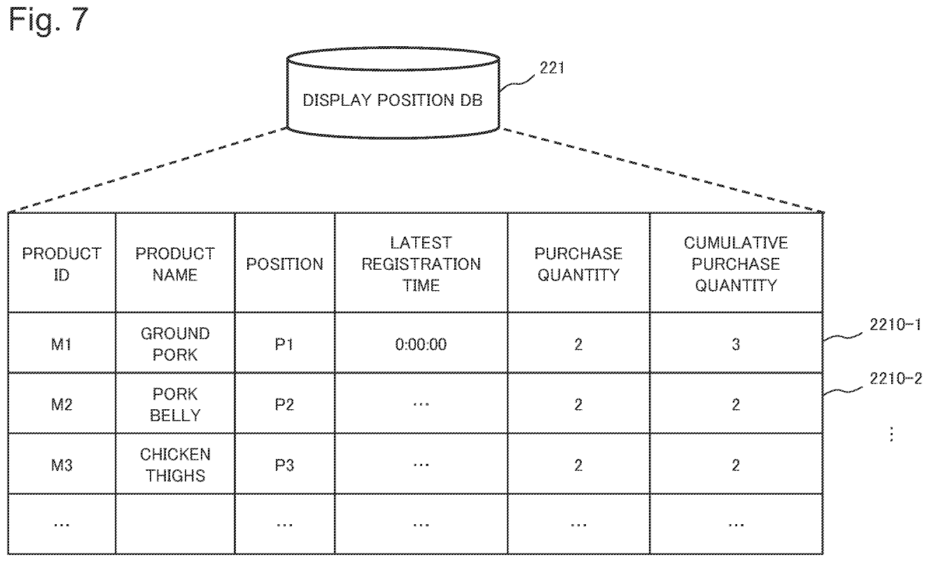

FIG. 7 is an explanatory diagram illustrating an example of the content stored in the display position DB 221. The display position DB 221 is a database for managing the display position of each product. The display position DB 221 has fields such as product ID, product name, position, latest registration time, cumulative purchase quantity, purchase quantity, and the like, for example. By setting information in each field, one record 2210 (2210-1, 2210-2, or the like) is registered in the display position DB 221.

The product ID is an identifier of a product. In the field of the product ID, product information is set. The product name is a name of a product. The position is a display position of a product in a store. The position is represented by various methods such as a coordinate position in a store, a shelf number, a passage number, and the like. In the field of the position, position information is set. The latest registration time is the latest registration time of the product display position by the registration device 21. For example, “x:x:xx” indicates “x hours, xx minutes, and xx seconds”. Time information is set in the field of the latest registration time.

The purchase quantity is the purchase quantity of the product with respect to the display position of the product at the latest registration time. Here, the purchase quantity is the number of purchases, the amount of purchases, and the like. For example, in a product managed by the number of grams or the like, the purchase quantity is the amount of purchases. For example, in a product managed by the number or the like, the purchase quantity is the number of purchases. For easy understanding, the purchase quantity will be described below as the purchase quantity. In the field of the purchase quantity, purchase quantity information or the like is set. The cumulative purchase quantity is a cumulative purchase quantity for the product display position. The cumulative number of purchases may be counted on a customer basis. Alternatively, the cumulative purchase quantity may be counted in units of position information. The cumulative purchase quantity may be, for example, the cumulative purchase quantity obtained by performing the product registration operation at the same position by the same customer. In addition, the cumulative purchase quantity may be, for example, the cumulative purchase quantity obtained by performing the product registration operation at the same position regardless of the customer. Although not illustrated, two kinds of fields of the cumulative purchase quantity may be provided in the display position DB 221 so that both of the cumulative purchase quantities can be managed. In the record 2210-1, “M1”, a product name “ground pork”, a position “P1”, a latest registration time “0:00:00”, a cumulative purchase quantity “3”, and a purchase quantity “2” are set as a product ID.

For example, information is preset in the fields of the product ID and the product name for each record 2210, and information is registered and updated in real time by the information processing device 20 in the fields of the position, the latest registration time, the cumulative purchase quantity, and the purchase quantity. Note that registration and update examples of each piece of information in the fields of the position, the latest registration time, the cumulative purchase quantity, and the purchase quantity will be described later in the description of each functional unit illustrated in FIG. 6. Furthermore, the display position DB 221 may include other fields, for example. For example, other fields include a field in which identifiers of all customers who have registered products at the display position can be set. Alternatively, examples of the other fields include a field in which an identifier of a customer who has registered a product at the latest registration time can be set. As a result, the information processing device 20 can determine which customer's product registration position of the registration device 21 is adopted as the product display position.

Here, the position indicated by the information set in the field of the position of the record 2210 is referred to as a position for the record 2210. The latest registration time indicated by the information set in the field of the latest registration time of the record 2210 is referred to as the latest registration time of the record 2210. The cumulative purchase quantity indicated by the information set in the field of the cumulative purchase quantity of the record 2210 is referred to as a cumulative purchase quantity of the record 2210. The purchase quantity indicated by the information set in the field of the purchase quantity of the record 2210 is referred to as the purchase quantity of the record 2210.

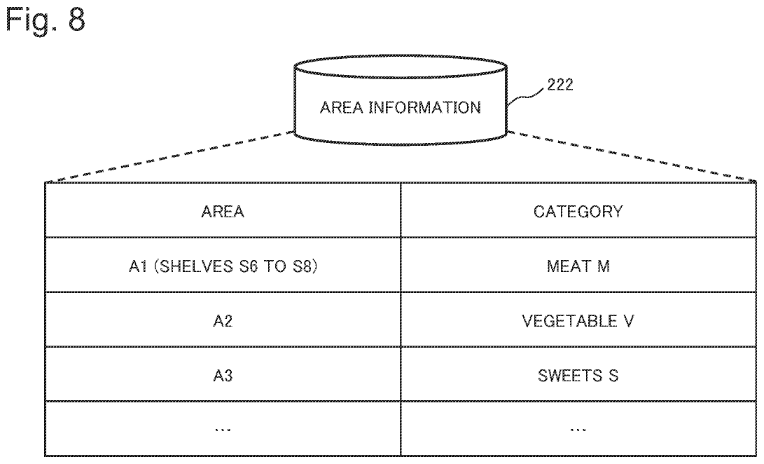

FIG. 8 is an explanatory diagram illustrating an example of the content stored in the area information 222. The area information 222 indicates association between an area in a store and a category of a product displayed in the area. For example, the area “A1” is, for example, a section of a product belonging to the category “meat M”. That is, it is a meat section. Although not illustrated in FIG. 8, for example, the area information 222 may have area information indicating an area range for each area. The area information may be represented by various methods such as a shelf number, a passage number, and a coordinate position in a store.

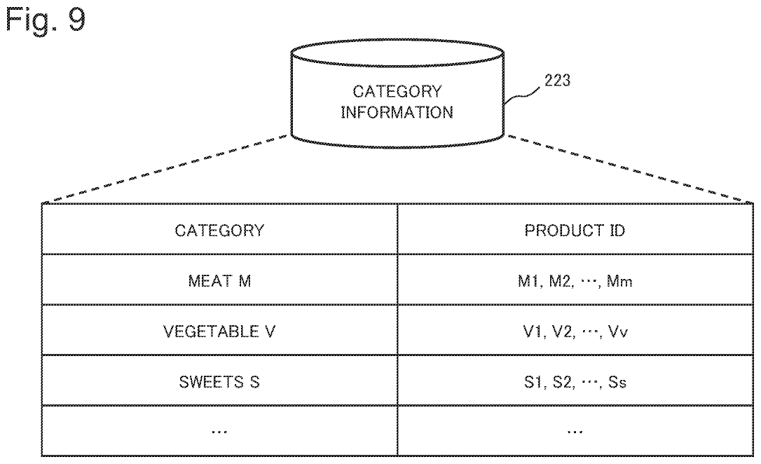

FIG. 9 is an explanatory diagram illustrating an example of the content stored in the category information 223. The category information 223 indicates, for example, association between a category and a product ID. As a result, the category information 223 indicates, for example, products belonging to each category. For example, the product IDs of the products belonging to the category “meat” are “M1” to “Mm”. As a result, the information processing device 20 can specify the category to which the product belongs based on the product ID data.

The various pieces of information illustrated in FIGS. 7 to 9 are not limited to the illustrated example. For example, various types of information may be achieved by adding a field to an existing database or the like. Furthermore, for example, in a case where the product information includes information that can identify a category, such as the first two digits of the product ID indicating the category of the product, the category information 223 may not be used.

The description of the storage content example of each piece of information stored in the storage unit 204 illustrated in FIG. 6 ends. Next, the operation of each functional unit illustrated in FIG. 6 will be described. The information processing device 20 includes the acquisition unit 201, the determination unit 203, and the output unit 202 as each functional unit. These functional units may share functions and processing with each other. For example, the output unit 202 may have some or all of the functions of the determination unit 203.

The acquisition unit 201 has the function of the acquisition unit 101 described in the first example embodiment. Specifically, the acquisition unit 201 acquires data (acquired data) including product information, position information, and time information. The product information is information on a product registered by the registration device 21 in product registration of a customer. As described above, the product information indicates a product by, for example, a product ID. Here, the product indicated by the acquired product information is referred to as a target product. The position information indicates, for example, the position of the registration device 21 at the time of registering the product. As described above, various examples of the position information include coordinate position information in a store, shelf identification information such as a shelf number, passage identification information such as a passage number, and the like. Here, a position associated to the position information is referred to as a registration position. The time information indicates a time at which the product is registered. The time indicated by the time information is referred to as a registration time.

The acquired data may include purchase quantity information. The purchase quantity information indicates the purchase quantity of the registered product. The acquisition unit 201 may acquire identification information of a customer, identification information of the registration device 21, and the like. Examples of the identification information of the customer include customer ID information of the customer who has registered the product. The purchase quantity information may be acquired as a part of the product information.

The various types of information acquired by the acquisition unit 201 can be variously changed according to the determination method by the determination unit 203 and the processing of each determination method. Specifically, the acquisition unit 201 receives various data from the registration device 21 via, for example, a communication network or the like.

The output unit 202 has the function of the output unit 102 described in the first example embodiment. The output unit 202 outputs the position information and the product information included in the acquired data. The output unit 202 may output the selected position information and product information. The acquired data may be selected by the determination unit 203. For example, the determination unit 203 determines whether to set the registration position as the display position of the target product in the store. In a case where it is determined that the registration position is to be the display position of the target product in the store, the output unit 202 outputs the position information and the product information. On the other hand, in a case where it is determined that the registration position is not to be the display position of the target product in the store, the output unit 202 does not output the position information and the product information.

The output unit 202 includes, for example, a registration unit 211 and a display control unit 212. Furthermore, the output unit 202 may have a configuration including either the registration unit 211 or the display control unit 212.

For example, the registration unit 211 registers the position information and the product information included in the acquired data in the storage unit 204. Specifically, the registration unit 211 registers the position information in the record 2210 associated to the target product in the display position DB 221. In addition, in a case where the purchase quantity information and the time information indicating the purchase quantity are acquired, the registration unit 211 registers the position information, the purchase quantity information, and the time information in the record 2210. In a case where the position and the registration position of the record 2210 associated to the target product are the same, the registration unit 211 adds the purchase quantity indicated by the purchase quantity information to the cumulative purchase quantity of the record 2210. Here, “two positions are the same” includes “substantially the same”. For example, it may be determined that the two positions are the same if they are within a predetermined range. As a result, the purchase quantity of the target product purchased at the same position is accumulated. On the other hand, in a case where the position of the record 2210 associated to the target product is different from the registration position, the registration unit 211 sets the purchase quantity indicated by the purchase quantity information with respect to the cumulative purchase quantity of the record 2210. For the registration unit 211, whether to perform registration differs depending on the determination result by the determination unit 203.

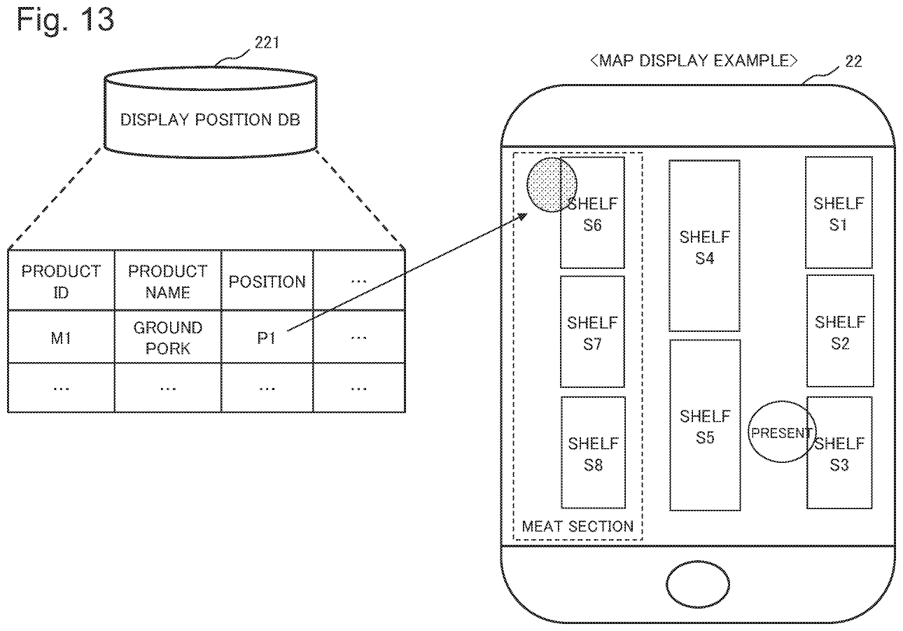

For example, the display control unit 212 causes the output device to output the position information and the product information included in the acquired data. Examples of the output device include a display, a lighting device such as a lamp, a printer, a plotter, a speaker, an earphone, and the like. In the system 2 of FIG. 4, the display control unit 212 causes the display device 22 to display the position information and the product information in association with each other. A display example of the map will be described later with reference to FIG. 13.

Here, the determination unit 203 and the output unit 202 will be described in detail using Determination Examples 1 to 3. Determination Example 1 is the determination based on the position associated to the category of the product, and Determination Example 2 is the determination based on the purchase quantity. Determination Example 3 is determination based on the registration order of the products.

### Determination Example 1

First, Determination Example 1 will be described. In Determination Example 1, in a case where the position information of the registration device at the time of registering the product corresponds to the area associated to the category of the product, the position information is adopted as the position information of the product. On the other hand, in Determination Example 1, when this position does not correspond to the area associated to the product, this position information is not adopted as the position information of the product.

The output unit 202 outputs the position information and the product information when the position information included in the acquired data is within an area associated to the category of the product indicated by the product information. For example, the determination unit 203 may determine whether the position information included in the acquired data is within an area associated to the category of the product indicated by the product information. Specifically, for example, the determination unit 203 determines whether the registration position is within an area associated to the category of the product in the store. Specifically, the determination unit 203 determines whether the registration position is within the area associated to the category of the target product based on the area information 222 and the category information 223.

More specifically, for example, the determination unit 203 specifies the category of the target product using the product ID (product ID of the target product) indicated by the product information from the category information 223 as a search key based on the category information 223. Then, the determination unit 203 specifies the area information 222 of the category from the category of the target product based on the area information 222. Then, the determination unit 203 determines whether the registration position is included in the area indicated by the area information 222. Accordingly, the determination unit 203 can determine whether the registration position is within the area associated to the category of the target product.

Alternatively, more specifically, for example, the determination unit 203 specifies in which area the registration position is included based on the area information 222. Then, the determination unit 203 specifies a category associated to the specified area based on the area information 222. Based on the category information 223, the determination unit 203 determines whether the product ID indicated by the product information is associated with the identified category. The determination unit 203 can determine whether the registration position is a position associated to the category of the target product. As described above, the search key is not particularly limited.

In a case where the registration position is within an area associated to the category of the target product in the store, the output unit 202 outputs the position information and the product information in association with each other. On the other hand, when the registration position is not within the area associated to the category of the target product in the store, the output unit 202 does not output the position information and the product information in association with each other.

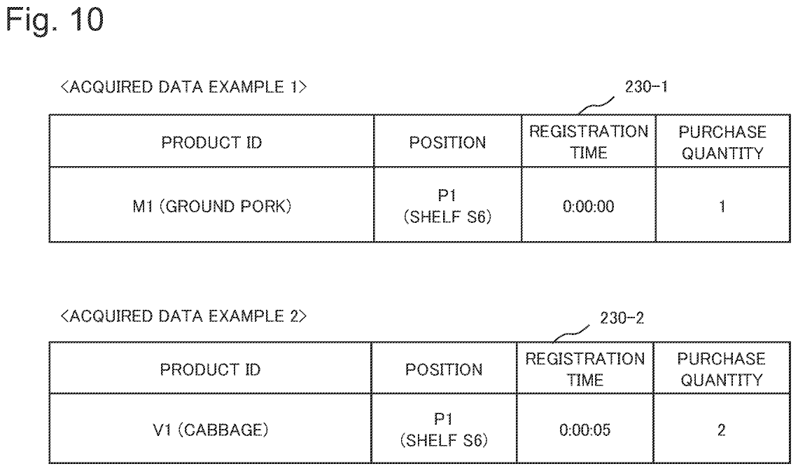

FIG. 10 is an explanatory diagram related to Determination Example 1. FIG. 10 illustrates acquired data example 1 and acquired data example 2. An example of determination by the determination unit 203 will be described for each piece of acquired data example. First, acquired data example 1 will be described. The acquired data example 1 will be described using the acquired data 230-1. The acquired data 230-1 includes product information, position information, registration time information, and purchase quantity information. In the acquired data 230-1, the product ID is “M1”, the position is “P1”, the registration time is “0:00:00”, and the purchase quantity is “1”. As illustrated in FIG. 10, the position “P1” is a position near the shelf S6 illustrated in FIG. 5. For example, the determination unit 203 specifies that the category to which the product ID “M1” belongs is “meat M” based on the category information 223. Then, the determination unit 203 specifies area “A1” associated to category “meat M” in the store based on the area information 222. The determination unit 203 determines whether position “P1” is included in area “A1”. As illustrated in FIG. 5, the area “A1” is in the vicinity of the shelves S6 to S8. The determination unit 203 determines that position “P1” is included in area “A1”. Therefore, for the acquired data 230-1, the determination unit 203 determines that the registration position is within the area associated to the category of the target product.

Then, the registration unit 211 updates the position, the latest registration time, the cumulative purchase quantity, and the purchase quantity with respect to the record 2210-1 of which the product ID is “M1” from the display position DB 221 based on the acquired data example 1. In a case where the position of the registered record 2210-1 is the same as the position “P1” of the acquired data example 1, the output unit 202 updates the latest reception time and the number of purchases based on the acquired data example 1. Then, the registration unit 211 adds the purchase quantity for the acquired data example 1 to the cumulative purchase quantity.

Next, acquired data example 2 will be described. The acquired data example 2 will be described using the acquired data 230-2. The acquired data 230-2 includes product information, position information, registration time information, and purchase quantity information. In the acquired data 230-2, the product ID is “V1”, the position is “P1”, the registration time is “0:00:05”, and the purchase quantity is “2”. As illustrated in FIG. 10, the position “P1” is a position near the shelf S6. For example, the determination unit 203 specifies that the category to which product ID “V1” belongs is “vegetable V” based on the category information 223. Then, the determination unit 203 specifies area “A2” associated to category “vegetable V” in the store based on the area information 222. The determination unit 203 determines whether position “P1” is included in area “A2”. As illustrated in FIG. 5, the area “A2” is in the vicinity of the shelves S4 to S5. The determination unit 203 determines that registration position “P1” is not included in area “A2”. Accordingly, with respect to the acquired data 230-2, the determination unit 203 determines that the registration position “P1” is not within the area “A2” associated to the category of the target product. Therefore, the registration unit 211 does not perform the registration processing on the acquired data 230-2.

For example, there is a low possibility that a refrigerated product or a frozen product is individually moved from an original shelf in a wagon sale or the like. Therefore, in Determination Example 1, the information processing device 20 may determine whether the registration position is at a position associated to the category for some products. This is the end of the description of Determination Example 1.

### Determination Example 2

Next, Determination Example 2 will be described. For example, in Determination Example 2, when the position information of the product X acquired from the customer A is different from the position information of the product X acquired from the customer B, the position information acquired from a customer with a large number of products purchased is adopted as the position information of the display position of the product X.

Here, the acquired data further includes purchase quantity information indicating the purchase quantity of the product of the customer. In a case where there are two or more pieces of acquired data and each piece of position information included in the two or more pieces of acquired data is different in the predetermined period, the output unit 202 outputs the position information and the product information included in the acquired data acquired by the operation of the customer with a large purchase quantity. Here, the acquired data is determined using the determination unit 203.

Specifically, the acquisition unit 201 acquires the acquired data including the product information, the position information, and the purchase quantity information indicating the purchase quantity of the target product. The determination unit 203 determines whether the registration position is set as the display position of the target product based on a comparison between the purchase quantity of the target product in the product registration of the customer different from the customer and the purchase quantity indicated by the acquired purchase quantity information. The purchase quantity of the target product in the product registration of the customer different from the customer is registered in the display position DB 221 in advance, for example.

An example of using the number of target products purchased registered in the display position DB 221 will be described. More specifically, for example, in a case where the position registered in the display position DB 221 is different from the registration position, the determination unit 203 compares the number of products purchased registered in the display position DB 221 with the number of products purchased indicated by the purchase quantity information. Here, the determination unit 203 may not determine whether the position registered in the display position DB 221 and the registration position are different from each other as to whether the positions are completely matched. For example, if the position registered in the display position DB 221 and the registration position are within a predetermined range, the determination unit 203 may determine that the positions are the same.

Furthermore, the position registered in the display position DB 221 is a position for the record 2210 associated to the target product among the records 2210 of the display position DB 221. Specifically, for example, the determination unit 203 determines whether the purchase quantity indicated by the purchase quantity information is larger than the purchase quantity of the target product registered in the display position DB 221. That is, in a case where the number of products purchased is larger than the number of products registered in the display position DB 221, the determination unit 203 sets the registration position as the display position of the product. On the other hand, in a case where the number of purchased products registered in the display position DB 221 is equal to or less than the number of purchased products, the determination unit 203 does not set the registration position as the display position of the product. Note that, in a case where the number of products purchased is the same, whether to set the registration position as the display position of the product is not particularly limited. For example, in a case where the number of products purchased indicated by the purchase quantity information is larger than the number of products purchased registered in the display position DB 221, the output unit 202 registers the acquired position information, purchase quantity information, and time information in the record 2210 associated to the target product in the display position DB 221. In addition, the output unit 202 sets the purchase quantity indicated by the purchase quantity information with respect to the cumulative purchase quantity for this record. For example, the output unit 202 does not update the display position DB 221 in a case where the purchase quantity indicated by the purchase quantity information is equal to or less than the purchase quantity of the target product registered in the display position DB 221.

Furthermore, for example, in a case where the position registered in the display position DB 221 for the target product is the same as the registration position, the output unit 202 updates the display position DB 221. Specifically, the output unit 202 registers the purchase quantity indicated by the purchase quantity information and the time indicated by the time information with respect to the purchase quantity and the latest registration time of the record 2210 associated to the target product in the display position DB 221. Then, the output unit 202 adds the purchase quantity indicated by the purchase quantity information to the cumulative purchase quantity of the record 2210. As a result, the display position DB 221 is updated.

An example of using the cumulative purchase quantity of products registered in the display position DB 221 will be described. When the position registered in the display position DB 221 for the target product is different from the registration position, the determination unit 203 determines whether the purchase quantity indicated by the purchase quantity information is larger than the cumulative purchase quantity. For example, in a case where the number of purchases indicated by the purchase quantity information is larger than the cumulative purchase quantity, the output unit 202 updates the display position DB 221. The update method is the same as the case of using the purchase quantity. When the purchase quantity indicated by the purchase quantity information is smaller than the cumulative purchase quantity, the output unit 202 does not update the display position DB 221. In a case where the position registered in the display position DB 221 is the same as the registration position, the output unit 202 updates the display position DB 221 similarly to the case of using the purchase quantity.

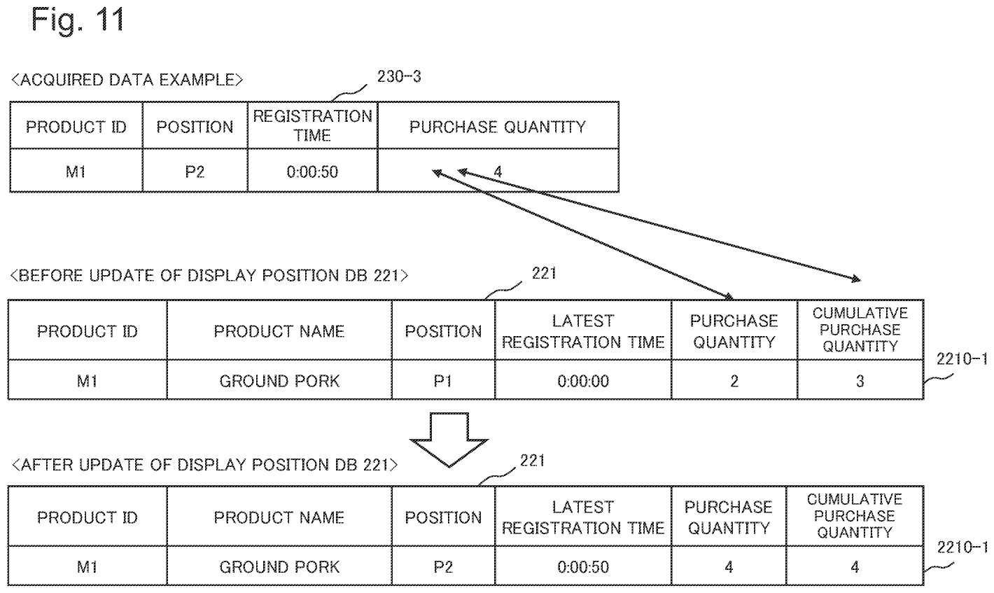

FIG. 11 is an explanatory diagram related to Determination Example 2. For example, the acquired data 230-3 has a product ID of “M1”, a position of “P2”, a registration time of “0:00:50”, and the number of purchases of “4”. In the record 2210-1 before update associated to the product ID “M1”, a position “P1” is set, which is different from the position “P2” of the acquired data. Therefore, when the purchase quantity is used, the determination unit 203 determines that the purchase quantity “4” for the acquired data is larger than the purchase quantity “2” of the record 2210-1 associated to the product ID “M1”. When the cumulative purchase quantity is used, the determination unit 203 determines that the purchase quantity “4” for the acquired data is larger than the cumulative purchase quantity “3” of the record 2210-1 associated to the product ID “M1”. Then, the output unit 202 sets a position “P2”, a latest registration time “0:00:50”, a cumulative purchase quantity “4”, and a purchase quantity “4” in the record 2210-1.

In Determination Example 2, an example has been described in which the display position DB 221 is updated by comparing the purchase quantity or the cumulative purchase quantity registered in the display position DB 221 with the purchase quantity indicated by the purchase quantity information included in the acquired data. The selection example using the purchase quantity is not limited thereto. For example, the acquired data may be stored in the storage unit 204 without being registered in the display position DB 221 in a predetermined period, and the acquired data to be registered may be selected from the stored acquired data. Specifically, the following method is used.

In a case where there are two or more pieces of acquired data including the same product information among the pieces of acquired data acquired in the predetermined period, the determination unit 203 outputs the position information and the product information included in the acquired data having a large purchase quantity from the acquired data. Here, the acquired data is selected by the determination unit 203. When there are two or more pieces of acquired data including the same product information among the pieces of acquired data acquired in the predetermined period, the determination unit 203 determines the acquired data having a large purchase quantity from the acquired data. The output unit 202 outputs the position information and the product information included in the determined acquired data. Specifically, the registration unit 211 registers the selected position information and product information in the display position DB 221.

In addition, the acquired data may be selected based on the cumulative total for each position information. In a case where there are two or more pieces of acquired data having the same product information among the pieces of acquired data acquired in the predetermined period, and the pieces of position information included in the two or more pieces of data are different, the output unit 202 outputs the position information and the product information in which the total purchase quantity for each position information is large. Here, the acquired data is selected by the determination unit 203. For example, the determination unit 203 determines whether there are two or more pieces of acquired data having the same product information among the pieces of acquired data acquired in the predetermined period. For example, in a case where there are two or more pieces of data, the determination unit 203 determines whether each piece of position information included in the two or more pieces of data is different. When the pieces of position information are different from each other, the determination unit 203 calculates the cumulative total of the purchase quantity for each piece of position information based on the purchase quantity information included in the two or more pieces of acquired data. The determination unit 203 selects position information with a large cumulative total from the position information. Then, the output unit 202 outputs the selected position information and product information. Specifically, the registration unit 211 registers the selected position information and product information in the display position DB 221.

### Determination Example 3

Next, Determination Example 3 will be described. For example, in Determination Example 3, in a case where a product of another category such as a vegetable is read immediately after products of a meat category are continuously read, position information related to a position where the product (vegetable) is registered is not adopted as the display position of the vegetable.

First, determination by the product registration operation for the same customer will be described as an example. The determination unit 203 determines whether the categories of the plurality of products registered immediately before the target product in the product registration of the customer are the same as the category of the target product. Here, the acquired data for the plurality of products may be acquired from the registration device 21 by the acquisition unit 201. Alternatively, for example, in a case where there is a server or the like that manages the registration contents of the product registration by each customer, the acquisition unit 201 may acquire the acquired data from the server. Alternatively, the information processing device 20 may manage pieces of acquired data in time series for each customer.

Specifically, the determination unit 203 specifies a category of each of the plurality of products and a category of the target product based on the category information 223. The plurality of products are, for example, a plurality of products registered immediately before the target product in the product registration by the same customer. The plurality of products are, for example, a product registered one ahead of the target product by the same customer, a product registered two ahead of the target product, and the like. Here, the plurality of products may be defined from a product registered immediately before the target product to a product registered a predetermined number of times before the target product. Alternatively, the plurality of products may be defined as products registered before a predetermined period from the time when the target product is registered.

For example, the determination unit 203 determines whether the categories of a plurality of products registered immediately before the target product are the same. That is, it is determined whether products of the same category have been successively registered before the target product. In a case where the categories of the plurality of products are not the same, the output unit 202 updates the display position DB 221. That is, when the plurality of products registered immediately before the target product are not in the same category continuously, the registration position is adopted as the display position of the target product.

On the other hand, when the categories of the plurality of products registered immediately before the target product are the same, the determination unit 203 determines whether the category of the target product is the same as the categories of the plurality of products. That is, when a target product is registered after products of the same category are continuously registered, it is determined whether the category and the category of the target product are the same. In a case where the category of the target product is different from the categories of the plurality of products, the determination unit 203 does not set the registration position as the display position of the target product. For example, in a case where the category of the target product is different from the categories of the plurality of products, the output unit 202 does not update the display position DB 221. On the other hand, for example, in a case where the category of the target product is the same as the categories of the plurality of products, the output unit 202 updates the display position DB 221. In addition, when the position information of the plurality of products and the position information of the target product are the same, the determination unit 203 may determine whether the categories of the plurality of products and the category of the target product are the same.

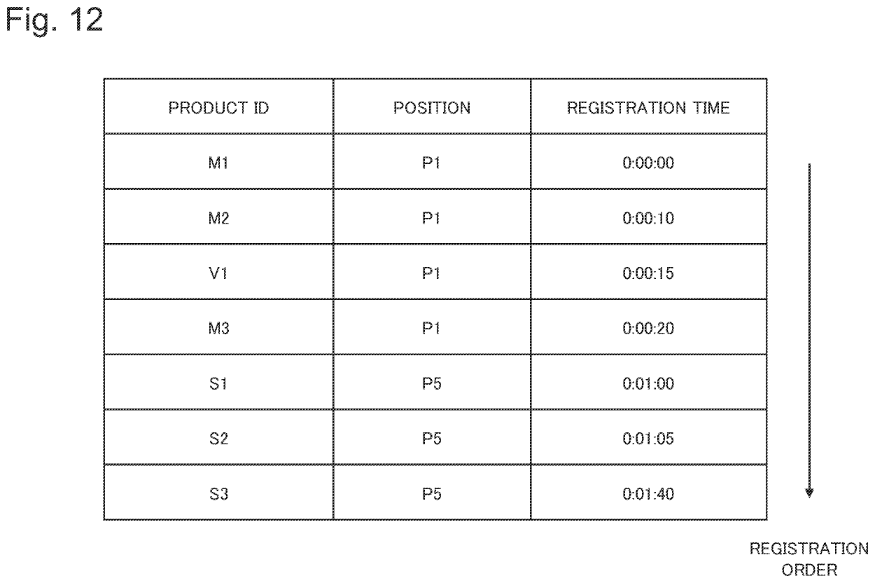

FIG. 12 is an explanatory diagram related to Determination Example 3. Here, an example in which product information is sequentially registered in product registration by the same customer will be described. First, a case where the acquired data of the product ID “V1” is focused will be described. The determination unit 203 determines whether the registration position “P1” of the product indicated by the product ID “V1” is set as the display position of the product ID “V1”. The product IDs of the two different products registered immediately before the product ID “V1” are the product ID “M1” and the product ID “M2”. Specifically, for example, the determination unit 203 refers to the category information 223 to specify the categories of the product ID “M1” and the product ID “M2”. Both the category of the product ID “M1” and the category of the product ID″ M2″ are “meat M”. Since the product ID “M1” and the product ID “M2” are in the same category based on the category information 223, the determination unit 203 specifies the category “vegetable V” of the product ID “V1”. Then, the determination unit 203 determines whether the category “vegetable V” of the product ID “V1” is identical to the category “meat M” of the product ID “M1” and the product ID “M2”. Since the category “vegetable V” of the product ID “V1” is not the same as the category “meat M” of the product ID “M1” and the product ID “M2”, the registration unit 211 does not update the display position DB 221.

Next, a case where the acquired data of the product ID “M3” is focused will be described. The determination unit 203 determines whether the registration position “P1” of the product indicated by the product ID “M3” is set as the display position of the product ID “M3”. Based on the category information 223, the determination unit 203 specifies a category of the product ID “V1” and a category of the product ID″ M2″ registered immediately before the product ID “M3”. For example, since the category “vegetable V” of the product ID “V1” and the category “meat M” of the product ID “M2” are different, the registration unit 211 updates the display position DB 221 such that the registration position “P1” is the display position of the product ID “M3”. As described above, in a case where the categories of the plurality of products registered immediately before the target product are not the same, the registration unit 211 updates the display position DB 221. That is, in a case where the categories are not continuously the same, the registration unit 211 sets the registration position as the display position.

Next, a case where a product ID “S3” is newly registered will be described. The determination unit 203 determines whether the registration position “P5” of the product indicated by the product ID “S3” is set as the display position of the product ID “S3”. Based on the category information 223, the determination unit 203 specifies a category of the product ID “S1” and a category of the product ID “S2” registered immediately before the product ID “S3”. For example, since the category “sweets S” of the product ID “S1” and the category “sweets S” of the product ID “S2” are the same, the determination unit 203 specifies the category of the product ID “S3” based on the category information 223. Since the category “sweets S” of the product ID “S3” is the same as the category “sweets S” of the product ID “S1” and the product ID “S2”, the registration unit 211 updates the display position DB 221 such that the registration position “P5” is the display position of the product ID “S3”. As described above, in a case where the categories of the plurality of products registered immediately before the target product are the same as the category of the target product, the registration unit 211 updates the display position DB 221.

Furthermore, although not illustrated, in a case where the time interval between the registration time of the target product and the registration time of the product registered immediately before is short, the determination unit 203 may perform the determination according to Determination Example 3. For example, when the time interval from the previous registration to the current registration is long, there is a high possibility that the customer has moved from the position of the previous registration. On the other hand, when the time interval from the previous registration to the current registration is short, there is a low possibility that the customer has moved from the position of the previous registration. In a case where there is a high possibility that the customer has moved from the position of the previous registration, the determination unit 203 may not perform the determination according to Determination Example 3. Specifically, the determination unit 203 determines whether a result obtained by subtracting the registration time of the product registered immediately before from the registration time of the target product is a predetermined time or more. The predetermined time can be set by a user, an administrator, or the like of the information processing device 20. Then, for example, in a case where the subtraction result is less than the predetermined time, the registration unit 211 performs the determination according to Determination Example 3. On the other hand, for example, in a case where the subtraction result is a predetermined time or more, the registration unit 211 updates the display position DB 221 such that the registration position is the display position of the target product. Alternatively, as described above, the determination unit 203 may set a plurality of products registered before a predetermined period from the time when the target product is registered as comparison targets.

In the above description, an example of sequentially focusing on each piece of acquired data in one customer has been described. An example in which position information and the product information included in the acquired data are output, and an example in which position information and the product information included in the acquired data are not output have been described. Acquired data output from a plurality of pieces of acquired data in a predetermined period may be selected without focusing on one piece of acquired data.

In a case where there are at least three pieces of acquired data and the position information included in the acquired data is the same in the predetermined period, the output unit 202 outputs the product information and the position information included in the acquired data in which there are a plurality of categories of the same product in the acquired data. The predetermined period can be set by a user, an administrator, or the like of the information processing device 20. The specific method can be variously changed. For example, the acquired data by the operation of the same customer in the predetermined period may be set as the processing target, or the acquired data in the predetermined period may be set as the processing target without limiting the customer. As for whether the pieces of position information included in the three or more pieces of acquired data are the same, the pieces of position information may be continuous in time series or may not be continuous in time series.

Referring to FIG. 12, for example, seven pieces of acquired data (each row) are acquired in a predetermined period. The determination unit 203 determines whether there are at least three or more pieces of acquired data and the position information included in the three or more pieces of acquired data is the same in a predetermined period. In FIG. 12, since the first four pieces of acquired data in time series are at the position “P1”, the position information is the same. In addition, since the last three pieces of acquired data in time series are at the position “P5”, the position information is the same.

Since the position information is the same, the determination unit 203 outputs the product information and the position information included in the acquired data having a plurality of categories of the same product among the pieces of acquired data. The determination unit 203 specifies a category of each product based on the category information. In FIG. 12, the category of the third acquired data in time series among the pieces of acquired data at the position “P1” is “vegetable V”. The category of the acquired data other than the third acquired data among the pieces of acquired data at the position “P1” is “meat M”. Therefore, the output unit 202 outputs the position information and the product information included in the acquired data of which the category is “meat M”. On the other hand, the output unit 202 does not output the position information and the product information included in the acquired data of the category “vegetable V”.

In FIG. 12, the category of all the acquired data at the position “P5” is “sweets S”. Therefore, the output unit 202 outputs the product information and the position information included in each piece of acquired data of the position “P5”. As described above, each piece of acquired data illustrated in FIG. 12 may be acquired by an operation of the same customer. Alternatively, each piece of acquired data may be acquired by operation of a plurality of customers. FIG. 12 illustrates an example in which the pieces of acquired data including the same position information are continuous in time series. The pieces of acquired data having the same position information may not be continuous in time series.

The description of Determination Examples 1 to 3 ends. The determination examples can be variously changed. Determination Examples 1 to 3 may be combined. The order or the like of determination at the time of combination of Determination Examples 1 to 3 can be variously changed. For example, in a case where Determination Example 1 and Determination Example 2 are combined, in a case where the position of the registration device 21 that has registered the target product is a position associated to the category of the target product, the determination unit 203 compares the number of target products purchased with the number of target products purchased in the display position DB 221. In addition, in the case of using Determination Example 1 or Determination Example 3, the display position DB 221 may not have fields for the cumulative purchase quantity and the purchase quantity. In this manner, each field of the display position DB 221 may be added or deleted according to the determination method or the output method. Furthermore, the processing may be achieved by different functional units, for example, the processing is performed by the determination unit 203 for Determination Example 1, and the processing is performed by the output unit 202 for Determination Example 2. Furthermore, the processing may be achieved by different functional units, for example, a second determination unit for performing Determination Example 2 and a third determination unit for performing Determination Example 3.

In addition, the present disclosure is not limited to Determination Examples 1 to 3, and the determination unit 203 may perform other determinations. If the position of the registration device 21 that has registered the target product is within the prohibited area, the determination unit 203 may determine not to use this position as the display position of the target product. For example, there is a low possibility that frozen products or refrigerated products are displayed in a passage without a shelf or the like. Therefore, a passage or the like may be set as a prohibited area for some products, and the determination unit 203 may determine whether the registration position is within the prohibited area.

In addition, in a case where the product information included in the acquired data acquired by the acquisition unit 201 is the same in a predetermined period, the output unit 202 may output the position information and the product information in which the number of pieces of acquired data for each position information is large. As a result, for example, in a case where there are a plurality of customers, the information processing device 20 can set the registration positions at which many customers have registered products as the display positions.

Next, a display example will be described. FIG. 13 is an explanatory diagram illustrating a display example. For example, the display control unit 212 causes the display device 22 to display a map indicating the position of the designated product based on the display position DB 221. In the example of FIG. 13, a map indicating the position “P1” of the product ID “M1” and the position of the customer is displayed on the display device 22. The product to be displayed is, for example, a product instructed by a customer, a product instructed by a store side, or a product instructed by a user of the information processing device 20.

Specifically, for example, the display control unit 212 specifies the position of the product to be displayed from the display position DB 221. Then, the display control unit 212 generates, for example, display data that allows the display device 22 to display a map indicating the specified position. Then, for example, the display control unit 212 transmits the display data to the display device 22. The display device 22 receives the display data. Then, the display device 22 displays the map on the display based on the display data.

Furthermore, in a case where the display device 22 generates display data related to a map, the display control unit 212 transmits the product information of the designated product and the position information of the designated product to the display device 22 based on the display position DB 221, for example. The display device 22 generates display data related to a map indicating a position of a product based on the associated product information and position information. Then, the display device 22 displays the map on the display based on the display data.

In FIG. 13, the display control unit 212 displays a map on the display device 22 using the product information and the position information registered in the display position DB 221. The display control unit 212 may display the product information and the position information acquired by the acquisition unit 201 without using the display position DB 221.

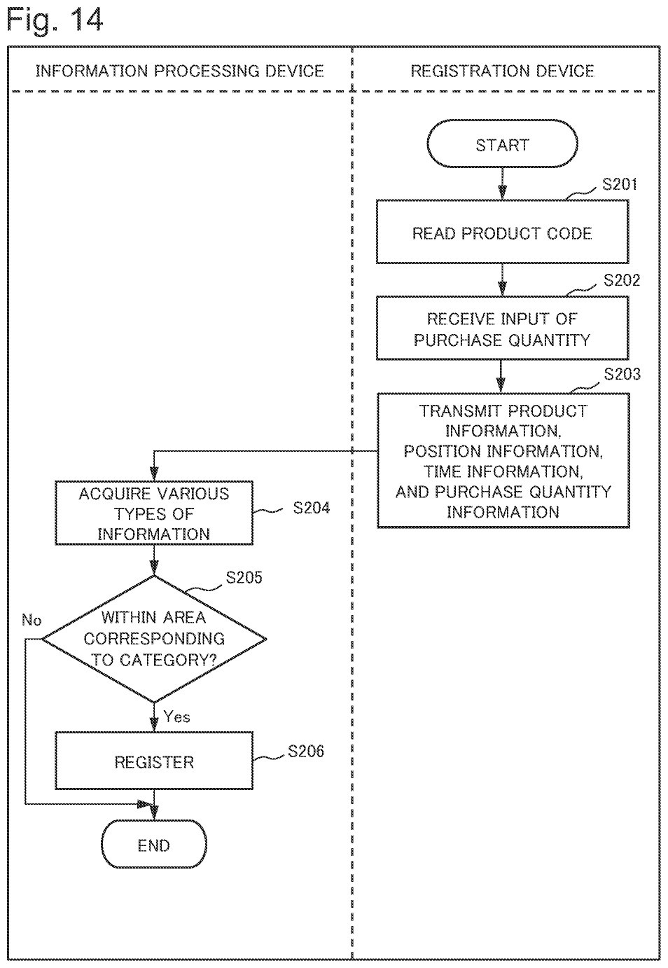

FIG. 14 is a sequence diagram related to Determination Example 1 of the system 2 according to the second example embodiment. In FIG. 14, for example, the registration device 21 reads a product code from a product in product registration by a customer (step S201). In step S201, the registration device 21 performs product registration by reading the product code from the product. Next, the registration device 21 receives an input of the purchase quantity (step S202). In step S202, the registration device 21 displays, for example, a screen for receiving an input of the purchase quantity for the product associated to the read product code. Then, in step S202, the registration device 21 receives the purchase quantity by the operation of the customer. With respect to the purchase quantity, in a case where the same product is continuously read a plurality of times without performing step S202, the registration device 21 may set the read number as the purchase quantity. Next, the registration device 21 transmits the product information indicating the product associated to the product code, the position information, and the time information of registration to the information processing device 20 (step S203).

The information processing device 20 acquires (receives) various types of information from the registration device 21 (step S204). The information processing device 20 determines whether the registration position is within an area associated to the category of the target product (step S205). Specifically, in step S205, the information processing device 20 specifies the category of the target product based on the category information 223, for example. In step S205, the information processing device 20 specifies an area associated to the category of the target product based on the area information 222. In step S205, the information processing device 20 determines whether the registration position is included in the area.

Next, in a case where the registration position is within the area associated to the category of the target product (step S205: Yes), the information processing device 20 proceeds to step S206. For example, the information processing device 20 registers the acquired various types of information in the display position DB 221 (step S206). Specifically, in step S206, in a case where the position of the record 2210 associated to the target product in the display position DB 221 is the same as the registration position, the information processing device 20 adds the purchase quantity indicated by the purchase quantity information to the cumulative purchase quantity of the record 2210. Then, in step S206, the information processing device 20 updates the latest registration time and the purchase quantity of the record 2210 based on the acquired various types of information. In step S206, when the position of the record 2210 associated to the target product in the display position DB 221 is different from the registration position, the information processing device 20 registers the purchase quantity indicated by the purchase quantity information with respect to the cumulative purchase quantity of the record 2210. Then, in step S206, the information processing device 20 sets the position, the latest registration time, and the number of purchases for the record 2210 based on the acquired various types of information.

In a case where the registration position is not within the area associated to the category of the target product (step S205: No), or after step S206, the information processing device 20 ends the flow.

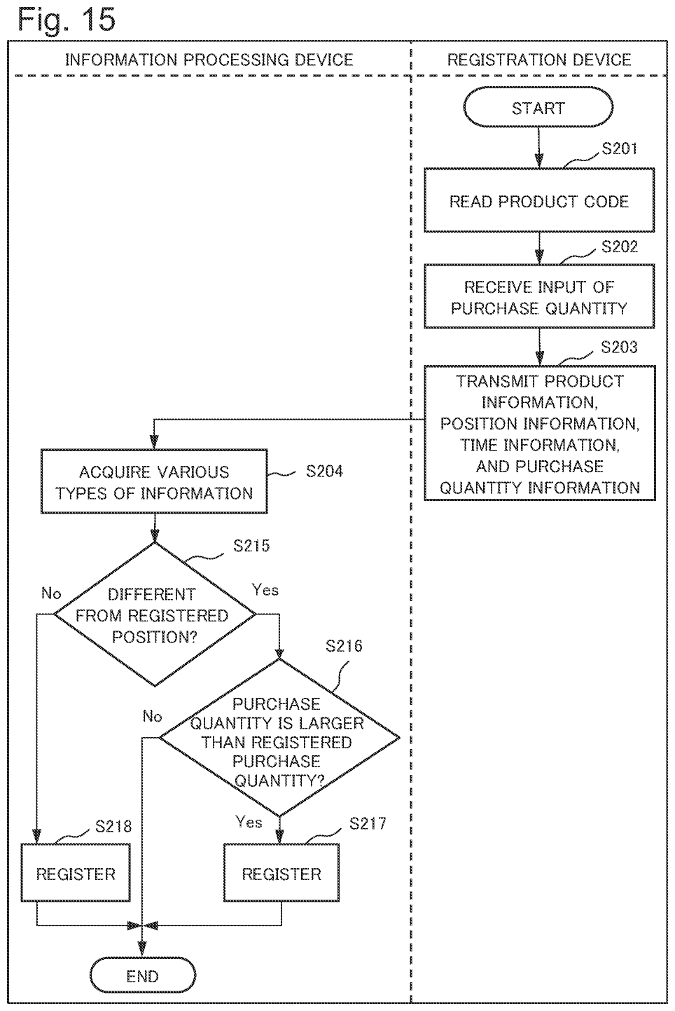

FIG. 15 is a sequence diagram related to Determination Example 2 of the system 2 according to the second example embodiment. Steps S201 to S204 illustrated in FIG. 15 are the same as steps S201 to S204 in FIG. 14, and thus detailed description thereof is omitted. Therefore, description will be made from step S215.

The information processing device 20 determines whether the registration position is different from the position registered in the record 2210 associated to the target product in the display position DB 221 (step S215). In a case where the registration position is different from the registration position (step S215: Yes), the information processing device 20 determines whether the purchase quantity indicated by the acquired purchase quantity information is larger than the purchase quantity registered in the record 2210 (step S216). In step S216, the cumulative purchase quantity registered in the record 2210 may be used instead of the registered purchase quantity.

In a case where it is determined that the purchase quantity indicated by the acquired purchase quantity information is not larger than the purchase quantity registered in the record 2210 (step S216: No), the information processing device 20 ends the flow. On the other hand, in a case where the number of purchases indicated by the acquired purchase quantity information is larger than the number of purchases registered in the record 2210 (step S216: Yes), the information processing device 20 registers the acquired various types of information in the display position DB 221 (step S217). In step S217, the information processing device 20 registers the position information, the display number information, and the time information in the record 2210 associated to the target product in the display position DB 221. Furthermore, in step S217, the information processing device 20 sets the purchase quantity indicated by the display quantity information with respect to the cumulative purchase quantity of the record 2210. After step S217, the information processing device 20 ends the flow.

In addition, in a case where the registration position is the same as the position registered in the display position DB 221 (step S215: No), the information processing device 20 registers various types of information acquired in the display position DB 221 (step S218). In step S218, the information processing device 20 registers the display number information and the time information in the record 2210 associated to the target product in the display position DB 221. In step S218, the information processing device 20 adds the purchase quantity indicated by the purchase quantity information to the cumulative purchase quantity of the record 2210. After step S218, the information processing device 20 ends the flow.

Furthermore, before step S215, the information processing device 20 may determine whether a difference between the time indicated by the time information and the time indicated by the time information registered in the record 2210 associated to the target product is a predetermined time or more. Then, in a case where the difference is not the predetermined time or more, the information processing device 20 proceeds to step S215. On the other hand, in a case where the difference is equal to or more than the predetermined time, the information processing device 20 may proceed to step S217 without performing step S215. In this way, in a case where the position information registered in the display position DB 221 is old, the information processing device 20 sets the new registration position as the display position.

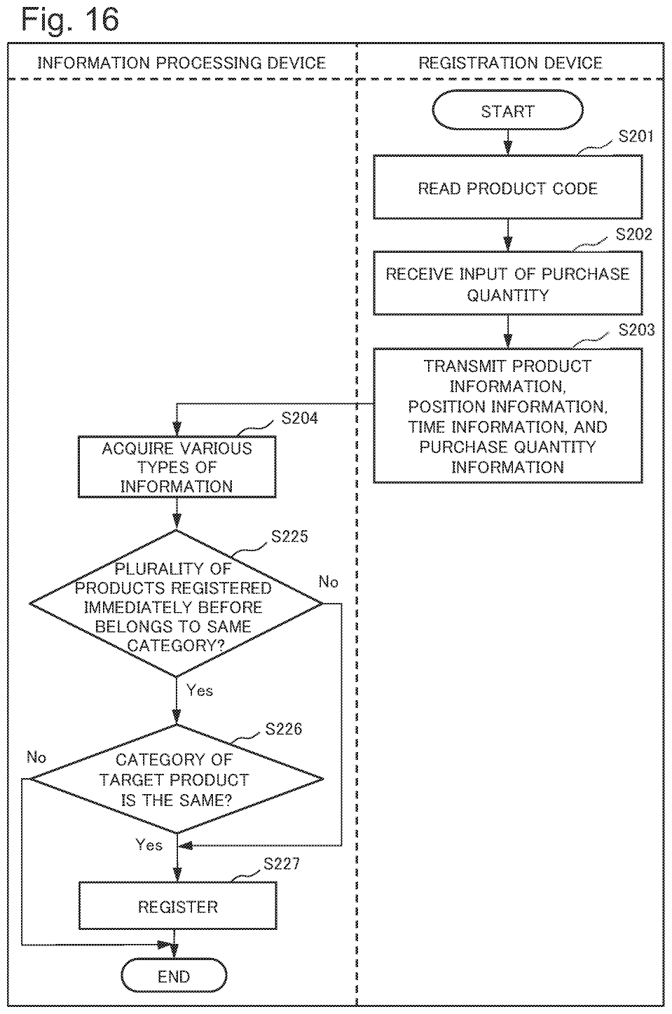

FIG. 16 is a sequence diagram related to Determination Example 3 of the system 2 according to the second example embodiment. Since steps S201 to S204 in FIG. 16 are the same as steps S201 to S204 illustrated in FIGS. 14 and 15, detailed description thereof is omitted. Therefore, description will be made from step S225.

The information processing device 20 determines whether a plurality of products registered immediately before the target product by the same customer belong to the same category (step S225). The product information indicating each of the plurality of products may be transmitted by the registration device 21 in step S203, and may be received by the information processing device 20 in step S204. Alternatively, the information processing device 20 may store a plurality of pieces of product information previously acquired for each customer in the storage unit 204 in association with each piece of time information. Furthermore, in step S225, the information processing device 20 specifies a category of each of the plurality of products based on the category information 223. Then, the information processing device 20 determines whether all the specified categories are the same.

Furthermore, in a case where the plurality of products registered most recently is not in the same category (step S225: No), the information processing device 20 proceeds to step S227. On the other hand, when a plurality of products registered most recently are successively in the same category (step S225: Yes), the information processing device 20 proceeds to step S226. The information processing device 20 determines whether the category of the registered product is the same as the categories of the plurality of products (step S226). The registered product is a product indicated by the newly acquired product information as described above. Specifically, in step S226, the information processing device 20 specifies the category of the target product based on the category information 223. Then, in step S226, the information processing device 20 determines whether the identified category of the registered product is the same as the categories of the plurality of products (step S226).

In a case where the category of the registered product is the same as the categories of the plurality of products registered immediately before (step S226: Yes), the information processing device 20 registers the acquired various types of information in the display position DB 221 (step S227). The information processing device 20 ends the flow after step S227.

Furthermore, in a case where the category of the newly registered product is not the same as the categories of the plurality of products registered immediately before (step S226: No), the information processing device 20 ends the flow.

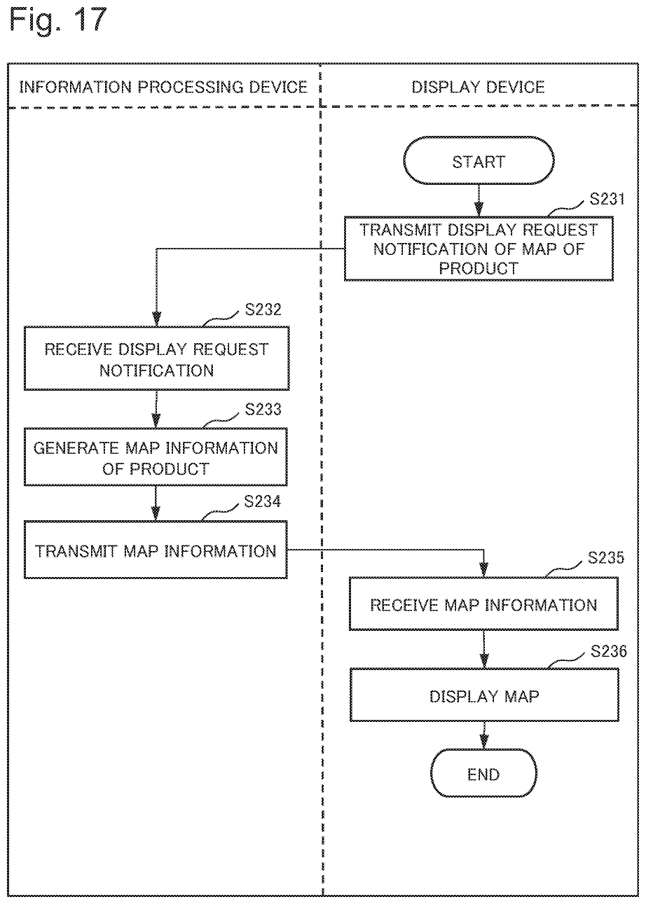

FIG. 17 is a sequence diagram illustrating a map display example of the system 2 according to the second example embodiment. The display device 22 transmits a display request notification of the map of the designated product to the information processing device 20 (step S231). For example, the product is designated by a user (a customer, a clerk, or the like) of the display device 22. The display request notification includes, for example, product information indicating a product designated by a user (customer, clerk, or the like) of the display device 22, position information indicating a position of the display device 22, and the like.

The information processing device 20 receives the display request notification from the display device 22 (step S232). Next, the information processing device 20 generates map information of the product based on the display request notification and the display position DB 221 (step S233). The method for generating the map information may be an existing technology, and is not particularly limited.

Next, the information processing device 20 transmits map information to the display device 22 (step S234). The display device 22 receives the map information from the information processing device 20 (step S235). Then, the display device 22 displays the map on a display or the like based on the map information (step S236). Then, the display device 22 ends the flow.

As described above, in the second example embodiment, the operation by the customer may be either or both of the product registration operation and the product search operation. Similarly to the first example embodiment, when both the product registration operation and the product search operation are used, the registration device 21 and the search device may be the same device or different devices, and are not particularly limited. For example, among the plurality of registration devices 21, some of the registration devices 21 may include the function of the search device, and some of the registration devices 21 may not include the function of the search device. Alternatively, among the plurality of search devices, some search devices may include the function of the registration device 21, and some search devices may not include the function of the registration device 21. In addition, the display device 22 and the search device may be the same device.

For example, in a case where the product information is obtained by the product search operation, the search device is used instead of the registration device 21. In this case, the product information is, for example, product information acquired by the search device at the time of searching for a product. The position information is, for example, position information when the product information is acquired by the search device. The time information is, for example, time information indicating the time when the product information is acquired by the search device. The purchase quantity information may be, for example, information indicating the purchase quantity input in the product search operation. The number of purchases is input at the time of search, for example, by an operation in which the customer confirms the total amount, the total weight, and the like. Note that the input purpose of the purchase quantity at the time of search is not particularly limited.

Next, effects of the second example embodiment will be described. Similarly to the information processing device 20 in the first example embodiment, the information processing device 20 in the second example embodiment described above can collect a large amount of position information of each product in real time. Therefore, the information processing device 20 can provide highly accurate position information in real time. Furthermore, the information processing device 20 can provide highly accurate position information without using an expensive device such as an RFID. Therefore, the information processing device 20 can reduce the cost of providing the position information. Furthermore, the information processing device 20 uses product registration used by a customer to purchase a product and product search used by a customer to search for a product. Therefore, the information processing device 20 can provide the position information to the customer without taking another time and effort. In addition, since the information processing device 20 uses the operation of the customer, it is possible to save the time and effort of the clerk.

Furthermore, the information processing device 20 determines whether the position at the time of acquisition of the product information acquired by the operation of the customer is set as the display position. For example, the information processing device 20 determines whether the position related to the registration device 21 that has registered the product in the product registration of the customer is set as the display position of the product. Alternatively, for example, the information processing device 20 determines whether the position related to the search device that has searched for the product in the product search of the customer is the display position of the product. As a result, the information processing device 20 can improve the accuracy of the position information of the product obtained by the operation of the customer.

Furthermore, in a case where the position at the time of acquisition is in an area associated to the category of the product, the information processing device 20 sets the position at the time of acquisition as the display position of the product. Taking the product registration operation as an example, for example, in a case where the position related to the registration device 21 is in an area associated to the category of the product, the information processing device 20 sets the position related to the registration device 21 as the product display position. For example, in a case where a meat product is registered in a meat section, the information processing device 20 sets a position related to the registration device 21 as a display position of the meat product. On the other hand, in a case where the position related to the registration device 21 is not within the area associated to the category of the product, the information processing device 20 does not set the position related to the registration device 21 as the display position of the product. For example, in a case where vegetables are registered in the meat section, the information processing device 20 does not set the position related to the registration device 21 as the display position of the vegetable product. As a result, in a case where the product information is acquired by the operation of the customer in the area associated to the category of the product, the information processing device 20 can set the position of the registration device 21 as the display position of the product. Therefore, the information processing device 20 can improve the accuracy of the position information of the product.

Furthermore, for example, in a case where the number of products purchased is as small as one, there is a possibility that a child of the customer or the like has moved the product from another shelf, or there is a possibility that the customer has moved and registered the product. On the other hand, when the number of products purchased is large, there is a high possibility that the customer removes the product from the shelf on the spot and registers the product. Therefore, in a case where the position related to the registration device 21 of a certain customer is different from the position related to the registration device 21 of another customer, if the number of products purchased by the customer is larger than the number of products purchased in the registration of another customer, the information processing device 20 determines the position related to the registration device 21 of the certain customer as the product display position. For example, in a case where the customer A purchases three pieces of the product X and the customer B purchases one piece of the product X, the information processing device 20 adopts the position of Mr. A related to the registration device 21 as the display position of the product X. As a result, the information processing device 20 can set the position related to the registration device 21 by product registration of a customer who purchases a large number of products as the product display position. Therefore, the information processing device 20 can improve the accuracy of the position information of the product.

For a certain product, if the number of products registered or searched for the product at the same position is large, there is a high possibility that the product is displayed in the vicinity of the position. Therefore, the information processing device 20 outputs the position information and the product information included in the acquired data in which the cumulative number of purchases for each position information is large among the pieces of acquired data acquired in the predetermined period. As a result, the information processing device 20 can improve the accuracy of the position information of the product.

In a case where there are three or more pieces of acquired data and the position information included in the three or more pieces of acquired data is the same in the predetermined period, the information processing device 20 outputs the product information and the position information included in the acquired data in which there are a plurality of categories of the same product among the pieces of acquired data. As a result, the information processing device 20 can output, for example, the product information in which products of the same category are searched or registered and the position information at the same position. As a result, the information processing device 20 can improve the accuracy of the position information of the product. Furthermore, the information processing device 20 may not output the product information and the position information in which products of the same category are not registered at the same position in the predetermined period. Therefore, the information processing device 20 can improve the accuracy of the position information of the product. Furthermore, in a case where attention is paid to one customer, for example, in a case where products of different categories are newly registered after products of the same category are continuously registered, there is a possibility that the product is registered at a position away from the position where the product is displayed. Therefore, in a case where products of different categories are registered when products of the same category are continuously registered in the product registration of the customer, the information processing device 20 does not adopt the position related to the registration device 21 for products of different categories as the display position. As a result, the information processing device 20 can improve the accuracy of the position information of the product.

In addition, the information processing device 20 registers the product information and the position information in the storage unit 204 in association with each other. As a result, the information processing device 20 can create information that can provide the position related to the registration device 21 that has registered the product as the display position of the product.

Furthermore, the information processing device 20 causes the output device to output the product information and the position information in association with each other. As a result, the information processing device 20 can cause the output device to output the position related to the registration device 21 that has registered the product as the display position of the product. For example, the information processing device 20 can display a display position of a product on a terminal device of a customer or a clerk in response to a request from the customer or the clerk.

Furthermore, the information processing device 10 according to the first example embodiment and the information processing device 20 according to the second example embodiment may be combined with existing technologies. In the display position DB 221, for example, position information may be registered in advance by a clerk. Then, the information processing device 20 may update the display position DB 221 to the latest state. Furthermore, for example, the position information provided by the information processing devices 10 and 20 is used for some of the plurality of products in the store. Then, for the remaining products among the plurality of products, position information specified by RFID or position information obtained by work of a clerk may be used.

Next, a case where the information processing device 10 according to the first example embodiment and the information processing device 20 according to the second example embodiment are implemented by a computer will be described. FIG. 18 is an explanatory diagram illustrating a hardware configuration example in a case where the information processing device is implemented by a computer. As illustrated in FIG. 18, an information processing device 30 is, for example, the information processing devices 10 and 20. The information processing device 30 includes a central processing unit (CPU) 301, a ROM 302, a RAM 303, a storage device 304, and a communication interface 305. The components are connected via a bus 306.

The CPU 301 controls the entire information processing device 30. For example, the CPU 301 may operate an operating system (OS) to control the entire information processing device 30. The CPU 301 may have a plurality of cores.

The information processing device 30 includes a ROM 302, a RAM 303, a storage device 304, and the like as storage units. Examples of the storage device 304 include a semiconductor memory such as a flash memory, an HDD, and an SSD. For example, the storage device 304 stores various programs such as an OS program, an application program, and a program according to the first or second example embodiment. Alternatively, the ROM 302 stores an application program. The ROM 302 may store the program according to the first or second example embodiment. Then, the RAM 303 is used as a work area of the CPU 301.

In addition, the CPU 301 loads a program stored in the storage device 304, the ROM 302, or the like. Then, the CPU 301 executes each process coded in the program. Further, the CPU 301 may download various programs via the communication network 310. Furthermore, the CPU 301 functions as a part or all of the information processing device 30. Then, the CPU 301 may execute processing or instructions in the illustrated flowchart based on the program.

The communication interface 305 is connected to a communication network 310 such as a local area network (LAN) or a wide area network (WAN) through a wireless or wired communication line. As a result, the information processing device 30 is connected to an external device or an external computer via the communication network 310. The communication interface 305 manages an interface between the communication network 310 and the inside of the information processing device 30. Then, the communication interface 305 controls input and output of data from an external device or an external computer.

However, the hardware configuration illustrated in FIG. 18 is an example, and other components may be added or some components may not be included. For example, the information processing device 30 may include a drive device or the like. Then, the CPU 301 may read a program or data from a recording medium attached to a drive device or the like to the RAM 303. Examples of the recording medium include an optical disk, a flexible disk, a magnetic optical disk, and a universal serial bus (USB) memory. Furthermore, for example, the information processing device 30 may include an input device such as a keyboard and a mouse, and an output device such as a display.

As described above, the information processing devices 10 and 20 according to the first and second example embodiments are implemented by the computer hardware illustrated in FIG. 18. Furthermore, the information processing devices 10 and 20 are achieved by one physically combined device. Alternatively, the information processing devices 10 and 20 may be achieved by connecting two or more physically separated devices in a wired or wireless manner.

Furthermore, there are various modifications of the methods for implementing the information processing devices 10 and 20. For example, each device may be achieved by an arbitrary combination of a computer and a program different for each component. In addition, a plurality of components included in each device may be achieved by an arbitrary combination of one computer and a program.

In addition, some or all of the constituent elements of the information processing devices 10 and 20 may be achieved by an application specific circuit. In addition, a part or all of the information processing device may be achieved by a general-purpose circuit including a processor such as a field programmable gate array (FPGA). Furthermore, a part or all of the information processing device may be achieved by a combination of a circuit for specific use, a general-purpose circuit, or the like. In addition, these circuits may be a single integrated circuit. Alternatively, these circuits may be divided into a plurality of integrated circuits. The plurality of integrated circuits may be configured by being connected via a bus or the like.

In addition, in a case where a part or all of each component of each device is achieved by a plurality of computers, circuits, and the like, the plurality of computers, circuits, and the like may be arranged in a centralized manner or in a distributed manner.

The position information provision method described in each example embodiment is achieved by being executed by the information processing devices 10 and 20. Furthermore, the position information provision method is implemented by a computer such as the information processing devices 10 and 20 executing a program prepared in advance. The program described in each example embodiment is recorded in a computer-readable recording medium such as an HDD, an SSD, a flexible disk, an optical disk, a flexible disk, a magnetic optical disk, or a USB memory. Then, the program is executed by being read from the recording medium by the computer. Furthermore, the program may be distributed via the communication network 310.

The functions of the components of the information processing devices 10 and 20 in the example embodiments described above may be achieved in hardware, like the information processing device 30 of the computer illustrated in FIG. 18. Alternatively, each component may be achieved by a computer device or firmware based on program control.

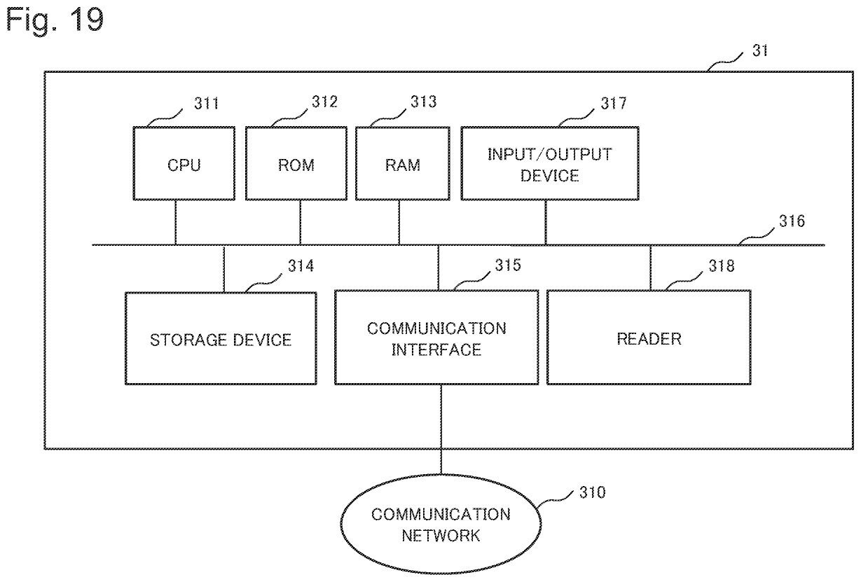

FIG. 19 is an explanatory diagram illustrating a hardware configuration example in a case where the registration device is implemented by a computer. As illustrated in FIG. 19, a registration device 31 is, for example, the registration device 21 described in the second example embodiment. Here, in particular, a case where the registration device 31 is a terminal device of a customer will be described as an example. The registration device 31 includes a CPU 311, a ROM 312, a RAM 313, a storage device 314, a communication interface 315, an input/output device 317, and a reader 318. The components are connected via a bus 316.

The CPU 311 controls the entire registration device 31. For example, the CPU 311 may operate the OS to control the entire registration device 31. The CPU 311 may have a plurality of cores.

The registration device 31 includes a ROM 312, a RAM 313, a storage device 314, and the like as storage units. Examples of the storage device 314 include a semiconductor memory such as a flash memory, an HDD, and an SSD. For example, the storage device 314 stores various programs such as an OS program and an application program, applications for product registration and checkout, and the like. Alternatively, the ROM 312 stores an application program. The ROM 312 may store the program according to the first or second example embodiment. Then, the RAM 313 is used as a work area of the CPU 311.

In addition, the CPU 311 loads a program stored in the storage device 314, the ROM 312, or the like. Then, the CPU 311 executes each process coded in the program. Further, the CPU 311 may download various programs via the communication network 310. In addition, the CPU 311 functions as a part or all of the registration device 31. Then, the CPU 311 may execute processing or instructions in the illustrated flowchart based on the program.

The communication interface 315 is connected to a communication network 310 such as a LAN or a WAN. As a result, the registration device 31 is connected to an external device such as an information processing device or an external computer via the communication network 310. The communication interface 315 manages an interface between the communication network 310 and the inside of the registration device 31. Then, the communication interface 315 controls input and output of data from an external device or an external computer.

The input/output device 317 includes, for example, an input device and an output device. Examples of the input/output device 317 include a touch panel display and the like. The reader 318 is, for example, a device capable of reading a product code such as a barcode. Examples of the reader 318 include a camera and the like.

Although the present disclosure has been described with reference to the example embodiments, the present disclosure is not limited to the example embodiments. The configuration and details of each of the present disclosure may include example embodiments to which various changes that can be grasped by those skilled in the art within the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although the plurality of operations are described in order in the form of a flowchart, the order of description does not limit the order of executing the plurality of operations. Therefore, when each example embodiment is implemented, the order of the plurality of operations can be changed within a range that does not interfere with the content. Furthermore, the search device may have a hardware configuration such as the registration device 31.

Some or all of the above example embodiments may be described as the following supplementary notes, but are not limited to the following.

(Supplementary Note 1)

An information processing device including:
an acquisition means configured to acquire data including product information indicating a product acquired by an operation of a customer and position information related to a position where the product information is acquired; and
an output means configured to output the position information and the product information included in the data acquired by the acquisition means.

(Supplementary Note 2)

The information processing device according to supplementary note 1, wherein
the output means outputs the position information and the product information in association with each other when the position information is within an area associated to a category of the product indicated by the product information.

(Supplementary Note 3)

The information processing device according to supplementary note 1 or 2, wherein
the data further includes purchase quantity information indicating a purchase quantity of the product of the customer, and
in a case where there are two or more pieces of data including the same product information among the pieces of data acquired by the acquisition means and respective pieces of position information included in the two or more pieces of data are different in a predetermined period, the output means outputs the position information and the product information included in the data acquired by an operation of a customer whose purchase quantity is large.

(Supplementary Note 4)

The information processing device according to supplementary note 1 or 2, wherein
the data further includes purchase quantity information indicating a purchase quantity of the product of the customer, and
in a case where there are two or more pieces of data including the same product information among the pieces of data acquired by the acquisition means and the pieces of position information included in the two or more pieces of data are different in a predetermined period, the output means outputs the position information and the product information in which a cumulative total of the purchase quantities for the respective pieces of position information is large.

(Supplementary Note 5)

The information processing device according to any one of supplementary notes 1 to 4, wherein
in a case where there are at least three or more pieces of the data acquired by the acquisition means and the pieces of position information included in the three or more pieces of the data are the same in a predetermined period, the output means outputs the product information and the position information included in the data in which there are a plurality of categories of the same product among the pieces of data acquired by the acquisition means.

(Supplementary Note 6)

The information processing device according to any one of supplementary notes 1 to 4, wherein
in a case where categories of a plurality of products acquired immediately before the product in the operation of the customer are the same and a category of the product indicated by the product information is the same as a category of the plurality of products, the output means outputs the position information and the product information in association with each other.

(Supplementary Note 7)

The information processing device according to any one of supplementary notes 1 to 6, wherein the output means includes a registration means configured to register the position information and the product information in a storage means.

(Supplementary Note 8)

The information processing device according to any one of supplementary notes 1 to 7, wherein the output means includes a display control means that causes a display means to display the position information and the product information.

(Supplementary Note 9)

A position information provision method including:
acquiring data including product information indicating a product acquired by an operation of a customer and position information related to a position where the product information is acquired; and
outputting the position information and the product information included in the data.

(Supplementary Note 10)

A program for causing a computer to execute:
acquiring data including product information indicating a product acquired by an operation of a customer and position information related to a position where the product information is acquired; and
outputting the position information and the product information included in the data.

This application is based upon and claims the benefit of priority from Japanese patent application No. 2020-161648, filed on Sep. 28, 2020, the disclosure of which is incorporated herein in its entirety by reference.

### REFERENCE SIGNS LIST

2 system
10, 20, 30 information processing device
21, 31 registration device
22 display device
101, 201 acquisition unit
102, 202 output unit
203 determination unit
204 storage unit
211 registration unit
212 display control unit
221 display position DB
222 area information
223 category information

What is claimed is:

1. An information processing device comprising:
a memory storing instructions; and
one or more processors configured to execute the instructions to:
acquire data including product information indicating a product acquired by an operation of a customer and position information related to a position where the product information is acquired; and
output the position information and the product information included in the data acquired.

2. The information processing device according to claim 1, wherein
the one or more processors are further configured to execute the instructions to:
output the position information and the product information in association with each other when the position information is within an area associated to a category of the product indicated by the product information.

3. The information processing device according to claim 1, wherein
the data further includes purchase quantity information indicating a purchase quantity of the product of the customer, and
the one or more processors are further configured to execute the instructions to:
in a case where there are two or more pieces of data including the same product information among the pieces of data acquired and respective pieces of position information included in the two or more pieces of data are different in a predetermined period, output the position information and the product information included in the data acquired by an operation of a customer whose purchase quantity is large.

4. The information processing device according to claim 1, wherein
the data further includes purchase quantity information indicating a purchase quantity of the product of the customer, and
the one or more processors are further configured to execute the instructions to:
in a case where there are two or more pieces of data including the same product information among the pieces of data acquired and the pieces of position information included in the two or more pieces of data are different in a predetermined period, output the position information and the product information in which a cumulative total of the purchase quantities for the respective pieces of position information is large.

5. The information processing device according to claim 1, wherein
the one or more processors are further configured to execute the instructions to:
in a case where there are at least three or more pieces of the data acquired and the pieces of position information included in the three or more pieces of the data are the same in a predetermined period, output the product information and the position information included in the data in which there are a plurality of categories of the same product among the pieces of data acquired.

6. The information processing device according to claim 1, wherein
the one or more processors are further configured to execute the instructions to:
in a case where categories of a plurality of products acquired immediately before the product in the operation of the customer are the same and a category of the product indicated by the product information is the same as a category of the plurality of products, output the position information and the product information in association with each other.

7. The information processing device according to claim 1, wherein
the one or more processors are further configured to execute the instructions to:
register the position information in association with the product information in a storage.

8. The information processing device according to claim 1, wherein
the one or more processors are further configured to execute the instructions to:
to display the position information in association with the product information in a display device.

9. A position information provision method comprising:
acquiring data including product information indicating a product acquired by an operation of a customer and position information related to a position where the product information is acquired; and
outputting the position information and the product information included in the data.

10. A non-transitory computer-readable recording medium that records a program for causing a computer to execute:
acquiring data including product information indicating a product acquired by an operation of a customer and position information related to a position where the product information is acquired; and
outputting the position information and the product information included in the data.

11. The information processing device according to claim 1, wherein
the operation of the customer is an operation in which the customer registers the product in a registration device.

12. The information processing device according to claim 1, wherein
the operation of the customer is an operation in which the customer searches for the product using a search device.

13. The information processing device according to claim 1, wherein
output the position information in association with the product information.

14. The information processing device according to claim 13, wherein
the one or more processors are further configured to execute the instructions to:
output the position information as a location information of display of the product indicated by the product information in a store.
